(19) United States
(12) Patent Application Publication
(10) Pub. No.: US 2025/0141625 A1
(43) Pub. Date: May 1, 2025

(54) FIRST AND SECOND COMMUNICATION DEVICES AND METHODS

(71) Applicant: Sony Group Corporation, Tokyo (JP)

(72) Inventors: Daniel VERENZUELA, Stuttgart (DE); Thomas HANDTE, Stuttgart (DE); Dana CIOCHINA-KAR, Stuttgart (DE); Ken TANAKA, Stuttgart (DE)

(73) Assignee: Sony Group Corporation, Tokyo (JP)

(21) Appl. No.: 18/691,471

(22) PCT Filed: Sep. 19, 2022
(86) PCT No.: PCT/EP2022/075936

§ 371 Date: Mar. 13, 2024

(30) Foreign Application Priority Data
Sep. 20, 2021 (EP) 21197735.0

(51) Int. Cl. H04L 5/00; H04L 1/00

(52) U.S. Cl. CPC H04L 5/0051; H04L 1/0059; H04L 5/0007; H04L 5/0092

(57) ABSTRACT

A first communication device that is configured to transmit data to a second communication device comprises circuitry configured to generate a number of one or more spatial streams, each spatial stream carrying payload data; map the payload data of each of the one or more spatial streams into a data field of a data unit, wherein a data unit comprises a preamble and a data field carrying one or more OFDM symbols and wherein one or more resource units (RU) are allocated to a data unit; reserve one or more subcarriers within one or more embedded training sequences (ETS) RU blocks (ERUBs) in one or more OFDM symbols in the data field of a data unit, wherein an ERUB spans part of or the complete bandwidth of a RU; and embed one or more ETSs into the one or more reserved subcarriers within one or more ERUBs.

### BACKGROUND

### Field of the Disclosure

The present disclosure relates to first and second communication devices and methods that are configured to communicate with each other.

### Description of Related Art

WLAN communications can be affected by interference from different sources like colli-sions from devices in the same basic service set (BSS), devices in overlapping BSS (OBSS), and devices from other technologies due to the use of unlicensed spectrum. Mul-tiple-input multiple-output (MIMO) technologies are used in WLAN to improve data rates and reliability. These technologies can also be used to detect and suppress the presence of interference affecting an ongoing transmission. The interference can be highly dynamic. For instance, it can change within the transmission of a data unit such as a physical protocol data unit (PPDU).

The “background” description provided herein is for the purpose of generally presenting the context of the disclosure. Work of the presently named inventor(s), to the extent it is described in this background section, as well as aspects of the description which may not otherwise qualify as prior art at the time of filing, are neither expressly nor impliedly admit-ted as prior art against the present disclosure.

### SUMMARY

It is an object to enable detection and/or estimation of dynamic interference and to provide corresponding communication devices and methods. It is a further object to provide a corresponding computer program and a non-transitory computer-readable recording medium for implementing the disclosed methods.

According to an aspect there is provided a first communication device configured to transmit data to a second communication device, the first communication device comprising circuitry configured to:
generate a number of one or more spatial streams, each spatial stream carrying payload data;
map the payload data of each of the one or more spatial streams into a data field of a data unit, wherein a data unit comprises a preamble and a data field carrying one or more OFDM symbols and wherein one or more resource units (RU) are allocated to a data unit;
reserve one or more subcarriers within one or more embedded training sequences (ETS) RU blocks (ERUBs) in one or more OFDM symbols in the data field of a data unit, wherein an ERUB spans part of or the complete bandwidth of a RU; and
embed one or more ETSs into the one or more reserved subcarriers within one or more ERUBs.

According to a further aspect there is provided a second communication device configured to receive data from a first communication device, the second communication device comprising circuitry configured to:
extract, from a received data stream, one or more embedded training sequences (ETSs) that are embedded into one or more reserved subcarriers within one or more ETS RU blocks (ERUBs) that are reserved in one or more OFDM symbols in the data field of a data unit, wherein an ERUB spans part of or the complete bandwidth of a resource unit (RU);
extract, from the received data stream, payload data of each of one or more spatial streams mapped into data fields of data units, wherein a data unit comprises a preamble and a data field carrying one or more OFDM symbols and wherein one or more resource units are allocated to a data unit;
reconstruct a number of one or more spatial streams, each spatial stream carrying payload data; and
perform detection and/or estimation of dynamic interference based on the extracted ETSs.

According to still further aspects a computer program comprising program means for causing a computer to carry out the steps of the method disclosed herein, when said computer program is carried out on a computer, as well as a non-transitory computer-readable recording medium that stores therein a computer program product, which, when executed by a processor, causes the methods disclosed herein to be performed are provided.

Embodiments are defined in the dependent claims. It shall be understood that the disclosed methods, the disclosed computer program and the disclosed computer-readable recording medium have similar and/or identical further embodiments as the claimed . . . and as defined in the dependent claims and/or disclosed herein.

One of the aspects of the disclosure is to enable detection and estimation of dynamic interference by use of embedded training sequences (ETSs) within the data field of a data unit (e.g. a PPDU) transmitted by the transmitter. For instance, in an embodiment some subcarriers within selected OFDM symbols in the data field of a PPDU are replaced with ETSs. Interference channel estimates obtained from ETS can be used at the receiver to suppress interference, e.g. via MIMO processing, and, in turn, increase the reliability of communications. In addition, the more reliable the transmissions are, the less retransmis-sions are needed, which reduces latency. Thus, the embedding of the one or more ETSs into particular RU blocks, called ERUBs, enables detection and/or estimation of interference and/or channel state by the second communication device. In embodiments, one or more (or all) subcarriers of one or more ERUBs are reserved for embedding ETSs.

In the context of the present disclosure, the term “intended transmitter” refers to the device (the transmitter, also called first communication device) that transmits signals through a wireless medium carrying data that the corresponding receiver (also called second communication device) wants to retrieve. In general, when the term “intended” is used in relation to features or properties of a communication system, it refers to the communication between the intended transmitter and receiver. The term “interferer” refers to another device (also called third communication device) that transmits signals in the same wireless medium disrupting or degrading the communication between the intended transmitter and receiver. The term “dynamic interference” refers to interference that displays changes in spatial channel properties (e.g., channel correlation matrix at the receiver) over the time duration of an intended data unit such as a PPDU.

The terms “intended transmitter” and “intended STA”, refer to the device (also called “first communication device” or “transmitter” in this disclosure) transmitting the signals that the receiver (e.g. another station or an AP; also called “second communication device” in this disclosure) wants to decode. This means that for the data unit, e.g. a PHY protocol data unit (PPDU; also generally called “data unit” in this disclosure), sent by the intended transmitter, the receiver can achieve synchronization and decode signaling fields that may pre-cede training fields. The “interfering transmitter” or “interferer” (also called “third communication device” in this disclosure) refers to another device (e.g. STA or AP) that is transmitting signals that disrupt the communication between the intended transmitter and the receiver.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWING

A more complete appreciation of the disclosure and many of the attendant advantages thereof will be readily obtained as the same becomes better understood by reference to the following detailed description when considered in connection with the accompanying drawings, wherein:

FIG. 1 shows a schematic diagram illustrating training fields and interference cases in WLAN.

FIG. 2 shows a diagram of LTF and data fields in WLAN PPDU.

FIG. 3 shows a diagram of an example of orthogonal sequence mapping with four spatial streams.

FIG. 4 shows a schematic diagram of a generator for generating the sounding field as described in WLAN 802.11ax;

FIG. 5 shows a schematic diagram of a transmitter for the data field in the IEEE 802.11ax standard.

FIG. 6 shows a diagram of LTF and data fields in WLAN PPDU illustrating the use of DCM for a single RU.

FIG. 7 shows a diagram illustrating RU locations in a 20 MHz high efficiency PPDU according to the IEEE 802.11ax standard.

FIG. 8 shows a diagram illustrating an RU allocation example according to the IEEE 802.11ax standard.

FIG. 9 shows a diagram illustrating a communication system including a first communication device and a second communication device according to the present disclosure.

FIG. 10 shows a flow chart of an embodiment of a first communication method of the first communication device according to the present disclosure.

FIG. 11 shows a flow chart of an embodiment of a second communication method of the second communication device according to the present disclosure.

FIG. 12 shows a flow chart of another embodiment of a first communication method of the first communication device according to the present disclosure.

FIG. 13 shows a diagram illustrating an example of ERUB allocation.

FIG. 14 shows a schematic diagram of an embodiment of a first communication device for the uplink and/or downlink of data field for BCC encoding including the insertion of ETS.

FIG. 15 shows a schematic diagram of an embodiment of a first communication device for the uplink and/or downlink of data field with LDPC encoding including the insertion of ETS.

FIG. 16 shows diagrams illustrating a full ETS ERUB allocation with an example of a channel sounding application.

FIG. 17 shows diagrams illustrating half ETS ERUB allocation with different ETS allocation strategies.

FIG. 18 shows a diagram illustrating partial ETS allocation 180 in a 52-tone EURB for BCC encoding.

FIG. 19 shows a mapping matrix used in an ETS mapper operation shown in FIG. 20.

FIG. 20 shows a schematic diagram illustrating ETS mapper operation for ERUBs included in 8 OFDM symbols.

FIG. 21 shows a flow chart of another embodiment of the receiver processing to decode a PPDU with ETS.

### DETAILED DESCRIPTION OF THE EMBODIMENTS

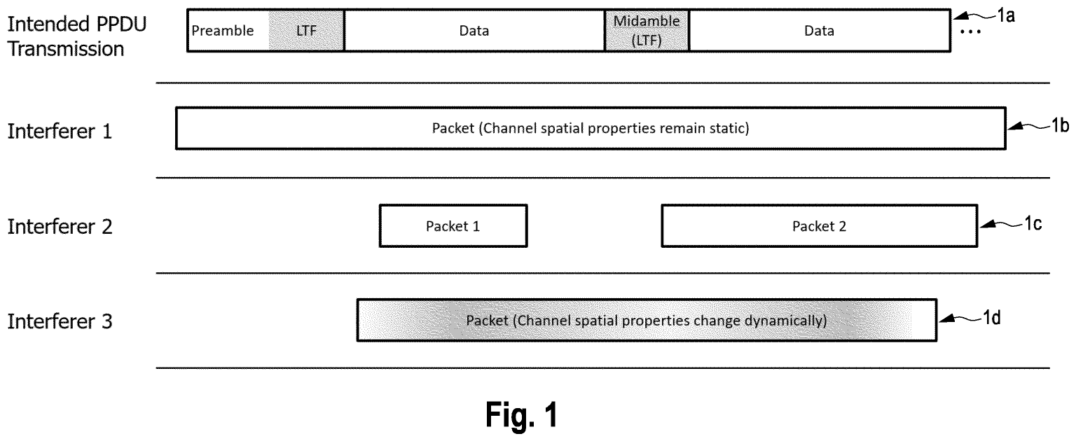

To harvest the most benefits from MIMO, channel estimation is necessary. In WLAN, the MIMO channel is estimated at the receiver from training signals, sent by the intended transmitter, included in the long training field (LTF). These LTF signals are placed in the preamble and optionally in midambles of a Physical Protocol Data Unit (PPDU) 1a as shown at the top of FIG. 1.

Since the interference can come from different types of devices, some outside the BSS or not belonging to the WLAN technology while residing inside the BSS, there are different cases to consider which are shown in FIG. 1. The first case, shown in the second row of FIG. 1, corresponds to the transmission from interferer 1, where its PPDU 1b overlaps entirely with the intended PPDU 1a and the spatial channel properties (e.g. channel correlation matrix at the receiver) remain static. For cases, where dynamic interference is present, there are no training signals suitable to enable interference suppression. More details on cases 2 and 3 and the problem to be solved will be given below.

Initially, a few features of the IEEE 802.11ax standard that are relevant for the presented solutions shall be given. First, pilot subcarriers and dual-carrier modulation (DCM) shall be explained.

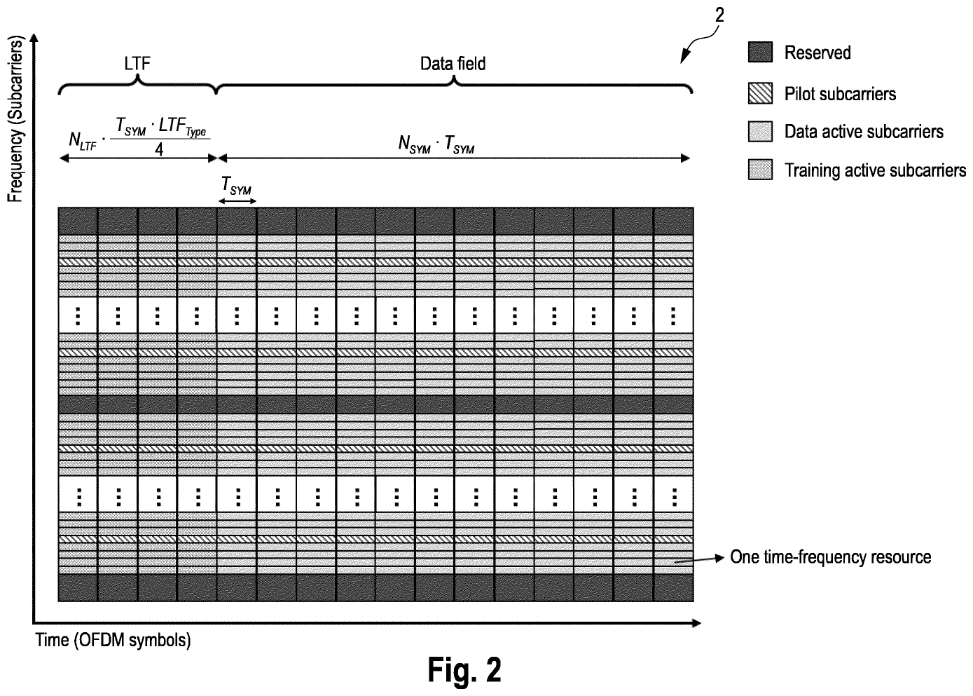

In the IEEE 802.11ax standard there are pilot signals inserted into the transmission of the PPDU, both in the preamble (LTF) and data fields of a PPDU 2 as shown in FIG. 2. These pilot signals are allocated into specific fixed pilot subcarriers based on the configuration of the PPDU bandwidth and resource unit (RU) size. The pilot subcarriers are used for phase and frequency tracking and estimation. Since these pilot subcarriers are placed at specific subcarriers and the corresponding training sequences are fixed and are the same for all spatial streams, they are not suitable for channel estimation.

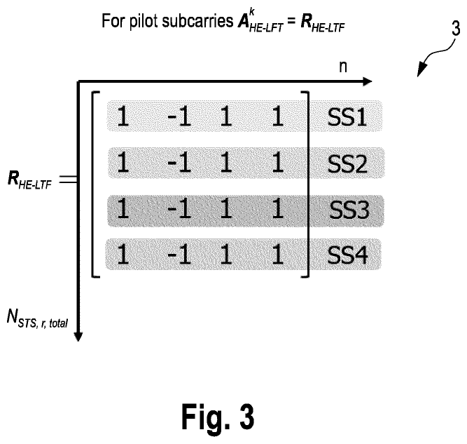

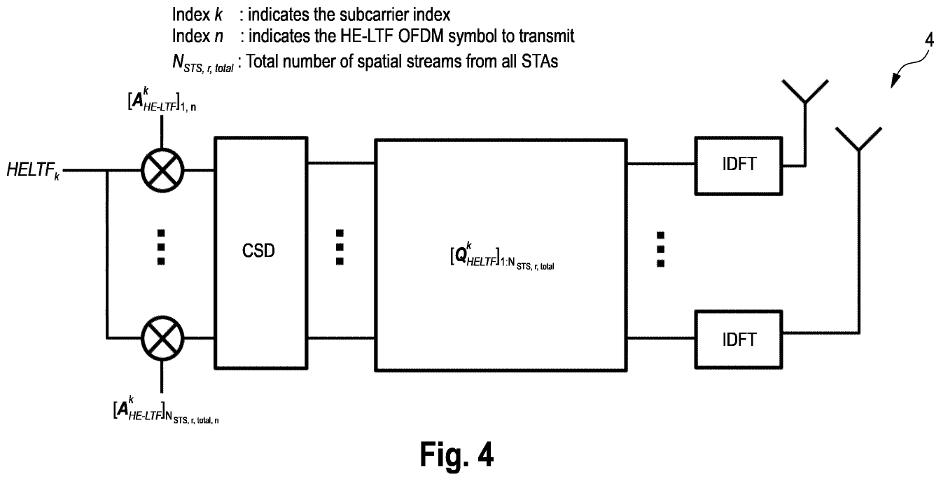

FIGS. 3 and 4 illustrate the generation of the LTF in the IEEE 802.11ax standard amend-ment where the insertion of pilot subcarriers is exemplified for the case of four spatial streams. The matrix RHE-LTF shown in FIG. 3 defines the sequences 3 that are inserted into the pilot subcarriers (HE meaning high efficiency). These sequences are selected to be equal for all spatial streams. This makes pilot subcarriers adequate for phase and frequency tracking but unsuitable for channel estimation since the receiver cannot separate the intended channel from each spatial stream.

FIG. 4 shows a schematic diagram of a generator 4 (of a transmitter) for generating the HE-LTF in described in WLAN 802.11ax (disclosed therein as FIG. 27-32, the description of which is herein incorporated by reference). For the data tones in the HE-LTF, the orthogonal sequences that support MIMO channel estimation are stored in the matrix A_{HE-LTF}^{k}=RH_{E-LTF} for pilot subcarriers. The index k indicates the subcarrier index. The index n indicates the HE-LTF OFDM symbol to transmit. NSTS_{,r,total} represents the total number of spatial streams from all STAs.

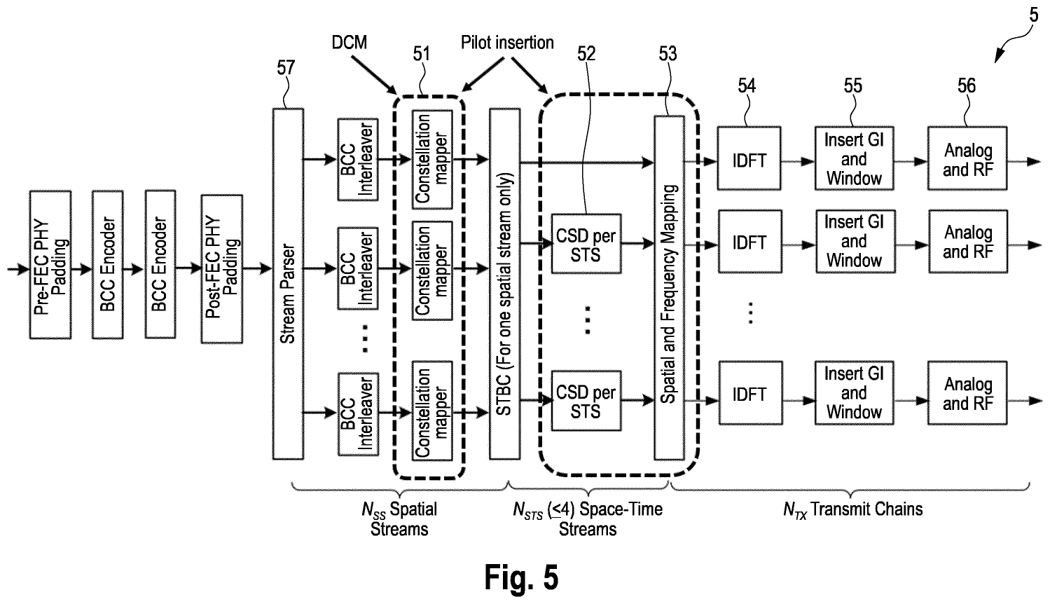

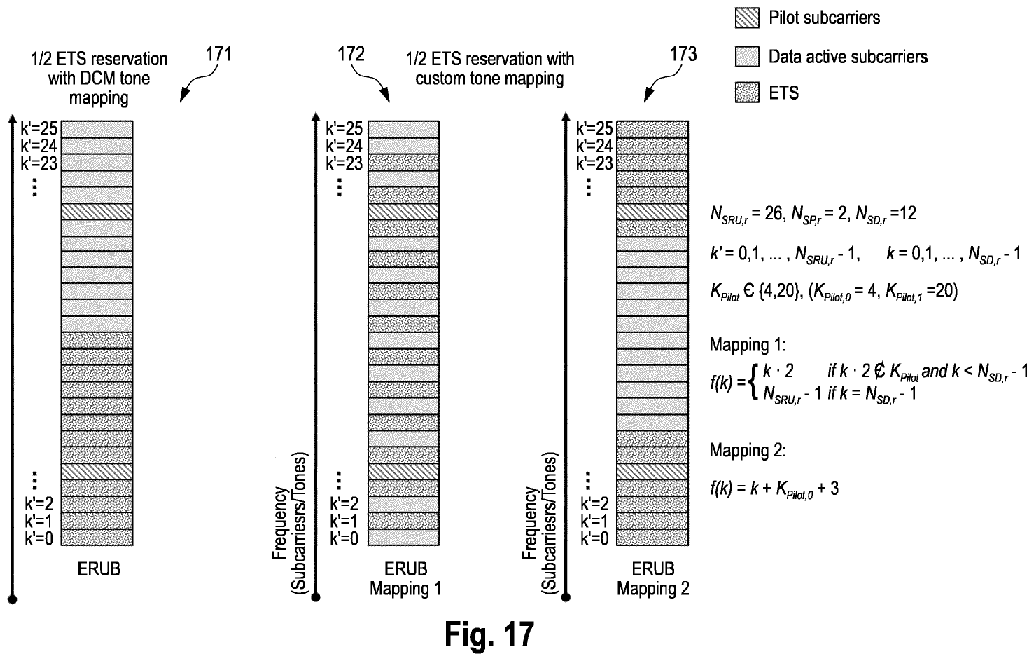

FIG. 5 shows a schematic diagram of a transmitter 5 of the data field in the IEEE 802.11ax (disclosed therein as FIG. 27-17, the description of which is herein incorporated by reference) in the case where a binary convolutional code (BCC) is used. The case where a low-density parity check code (LDPC) is used is very similar. The insertion of pilot subcarriers is performed within a subset of these transmitter blocks comprising the constellation mapper 51, cyclic shift diversity (CSD) block 52, the spatial and frequency mapping blocks 53 (as well as the blocks to their right, including IDFT blocks 54, insertion blocks 55 and analog and RF blocks 56), similar to the schematic diagram show in FIG. 4. The constellation mapper block has the main task of mapping encoded bits to complex modulated symbols. It incorporates the DCM tone mapping functionality, when enabled. The CSD block inserts cyclic shifts to decorrelate the transmissions from different spatial streams and avoid unintended beamforming effects. The spatial and frequency mapping blocks introduce beamforming effects (if enabled) and map the data allocated to subcarrier indices into the subcarriers to be modulated in the OFDM symbols.

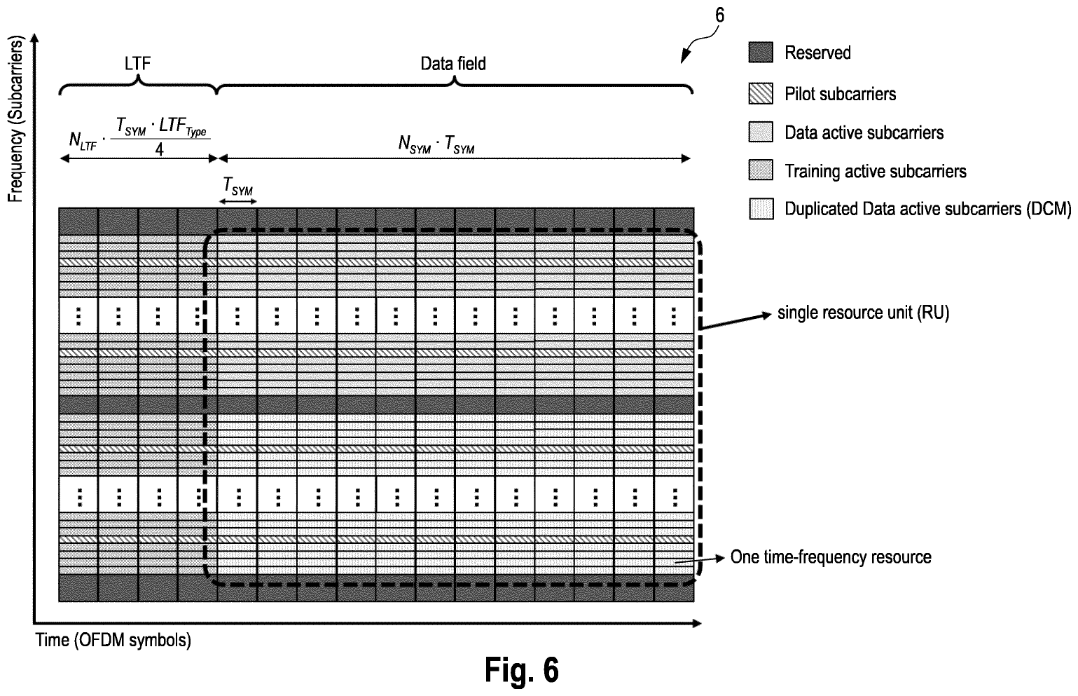

DCM is a modulation scheme that duplicates the transmitted data and allocates it into separated subcarriers, as illustrated in FIG. 6 showing LTF and data fields in WLAN PPDU 6 illustrating the use of DCM for a single RU. This method is used to enhance robustness against channel fading and interference and offers frequency diversity at the expense of reducing the data rate by half due to the duplication of transmitted data.

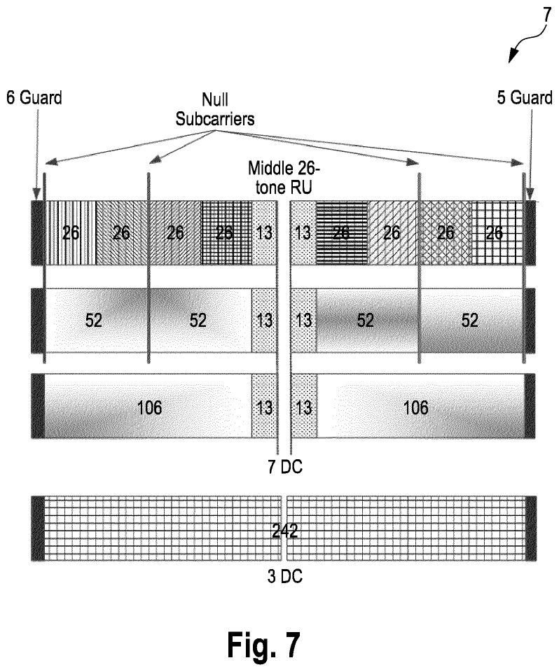

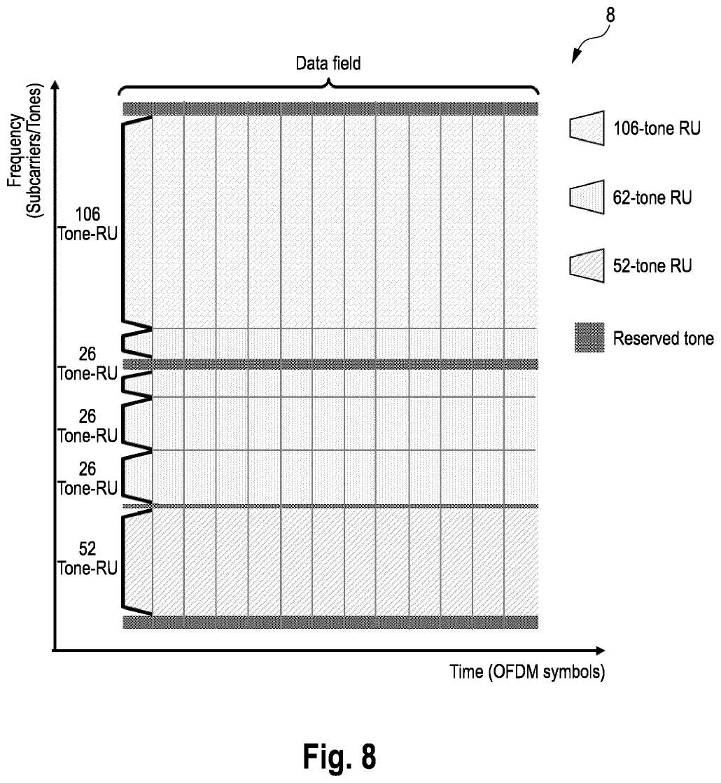

Next, an explanation of resource unit (RU) shall be given. The use of orthogonal frequency multiple access (OFDMA) was introduced in the IEEE 802.11ax standard to enable more efficient frequency resource allocation among users. The main principle is that the subcarriers that form an OFDM symbol are divided into disjoint groups and these groups are assigned to different users. In IEEE 802.11ax, a RU is defined as a group of subcarriers that can be allocated to a specific user. There are several sizes of RUs based on the number of tones (i.e. subcarriers) that are contained within them. An important aspect of the definition of RUs is that they do not change within the whole duration of the data field of a PPDU. FIGS. 7 and 8 show diagrams 7 and 8 illustrating the definition of RU sizes for a 20 MHz (FIG. 7; disclosed in IEEE 802.11ax as FIG. 27-5, the description of which is herein incorporated by reference) and an example of a RU resource allocation in a PPDU (FIG. 8).

As shown in FIG. 1, the LTF signals and the data field are transmitted at different time in-stances within a PPDU. This means that if the interference channel cannot be captured during the times where LTFs are transmitted, or if the interference channel changes between the LTFs and data transmission, the interference cannot be suppressed or the receiver that suppresses interference is mismatched which degrades performance. In this disclosure, these interference cases are referred to as dynamic interference. Some examples are illustrated by interferers 2 and 3 in FIG. 1 (third and fourth rows). In the case of interferer 2, there are two transmissions 1c that can originate from the same device with different spatial configurations (e.g., number of spatial streams and beamforming weights), or different devices with entirely different channels. For the case of interferer 3, the spatial properties of the channel change at a fast pace (this is illustrated by the color changes in the PPDU 1d) such that the interference channel estimates at the time LTFs are received are different from the interference channel in the data part of the intended PPDU. A combination of cases 2 and 3 is also possible.

To suppress dynamic interference, it may be necessary to detect and estimate the interference channel within the data field of a PPDU. The pilot signals included in pilot subcarriers are present in both the preamble and data of a PPDU. In principle, they could give initial estimates of the interference type. However, the main purpose of these pilots is phase and frequency tracking and not channel estimation. The number and location of the pilot subcarriers are fixed and the frequency gaps between them are in the order of MHZ, which makes them unsuitable for estimating frequency selective channels which are typi-cal in WLAN. In addition, since the pilot subcarriers are not designed for channel estimation, each spatial stream transmits the same training sequence, as shown in FIG. 3. This means that pilot subcarriers cannot be used to improve the estimation of intended channels.

The use of DCM can bring robustness against interference at the expense of reducing the data rate by half. However, DCM does not suppress the interference but rather attempts to avoid the presence of interference in a static fashion. Thus, it cannot adapt to changes in a dynamic interference scenario.

To enable detection and estimation of dynamic interference, this disclosure presents the concept of embedded training sequences (ETS) within the data field in WLAN. The main idea is to replace one or more subcarriers within selected OFDM symbols in the data field of a PPDU with training sequences. Herein, a time-frequency resource is referred to as a subcarrier within an OFDM symbol as shown in FIG. 2.

Before further details of the present disclosure will be explained, some essential terminology shall be explained.

An OFDM symbol is generally comprised of subcarriers (in the frequency domain) and oc-cupies the transmission bandwidth of a PPDU. A PPDU is made of several OFDM symbols that are transmitted one after the other in the time domain. The preamble is made of a first group of OFDM symbols and comes before the data field which is made of the rest of the OFDM symbols in the PPDU. There are generally several types of subcarriers, namely data subcarriers (used of transmitting data), pilot subcarriers (used of for phase and frequency tracking), and unused subcarriers (left empty to protect the integrity of the other subcarriers from hardware imperfections). If “subcarriers” are referred to in this disclosure without any particular attribute, it shall be assumed that “data subcarriers” are meant.

An RU (as defined in the standard IEEE 802.11ax) is a group of subcarriers (also called tones) within the data field of a PPDU. Thus, the RUs are often named in terms of tones, e.g., 26-tone RU, 242-tone RU, etc. The RU configuration or allocation, indicates how to divide the PPDU bandwidth into different RUs. This configuration is fixed for the entire data field (all OFDM symbols in the data field). The main purpose of having RUs is to allocate data from different users within the data field of same PPDU via OFDMA (orthogonal frequency division multiple access). This means that some RUs may be allocated to user A, others to user B, others user C etc., i.e., each RU can generally be allocated to a different user.

An ERUB is a new concept introduced in this disclosure. It comprises a block of an RU, into which ETSs are embedded. An ERUB contains the same number of subcarriers as the corresponding RU but it is mapped onto one or more OFDM symbols (instead of all OFDM symbols as in the regular case of RU mapping). Inside each ERUB, all or part of the subcarriers are reserved and filled with ETSs.

An RU block generally contains the same number of subcarriers as the corresponding RU, but it is mapped on to one or more OFDM symbols (instead of all OFDM symbols as in the regular case of RU mapping).

ETSs are training sequences that are inserted into the subcarriers reserved inside ERUBs. The amount of ETS is generally set by a tradeoff between performance of channel estimation and data resource. The more ETSs, the better channel estimation can be done, and in turn more a reliable recovery of the transmitted data can be achieved. However, this comes at the expense of having fewer resources for data, which may reduce the efficiency.

FIG. 9 shows a diagram illustrating a first communication device 10 (herein also called intended transmitter, representing e.g. a station STA) according to an aspect of the present disclosure for communicating with a second communication device 20 (herein also called receiver, representing e.g. an access point AP). The first communication 10 is able to exchange (receive and/or transmit) data with the second communication device 20 that may, optionally, exchange data with further communication devices (e.g. further stations that are not shown in FIG. 5). This communication, in particular one or more channels used for this communication, may be disturbed by interference, e.g. by a transmission of a third communication device 30 (herein also called non-intended or interfering transmitter, representing e.g. another STA or AP).

Each of the communication devices 10, 20, 30 comprises circuitry 11, 21, 31 that is configured to perform particular operations. The circuitries may be implemented by a respective processor or computer, i.e. as hardware and/or software, or by dedicated units or components. For instance, respectively programmed processors may represent the respective circuitries 11, 21, 31.

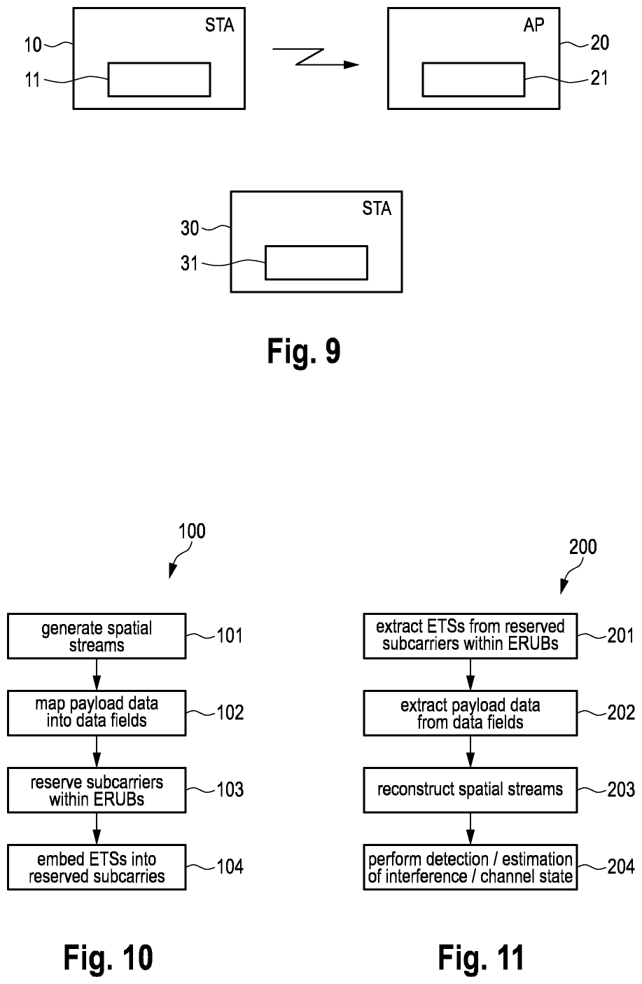

FIG. 10 shows a flow chart of an embodiment of a first communication method 100 of the first communication device 10 according to the present disclosure, which may be performed by the circuitry 11. In a first step 101 a number of one or more spatial streams is generated, each spatial stream carrying payload data. In a second step 102 the payload data of each of the one or more spatial streams are mapped into a data field of a data unit, wherein a data unit comprises a preamble and a data field carrying one or more OFDM symbols and wherein one or more RUs are allocated to a data unit. In a third step 103 one or more subcarriers within one or more ERUBs in one or more OFDM symbols are reserved in the data field of a data unit, wherein an ERUB spans part of or the complete bandwidth of a RU. In a fourth step one or more ETSs are embedded into the one or more reserved subcarriers within one or more ERUBs.

FIG. 11 shows a flow chart of an embodiment of a second communication method 200 of the second communication device 20 according to the present disclosure, which may be performed by the circuitry 21. In a first step 201, from a received data stream, one or more ETSs that are embedded into one or more reserved subcarriers within one or more ERUBs are extracted. In a second step 202, from the received data stream, payload data of each of one or more spatial streams mapped into data fields of data units are extracted. In a third step 203 a number of one or more spatial streams are reconstructed. In a fourth step 204 detection and/or estimation of interference and/or channel state are performed based on the extracted ETSs.

In the following, various embodiments and potential implementations of the disclosed communication devices and methods will be described.

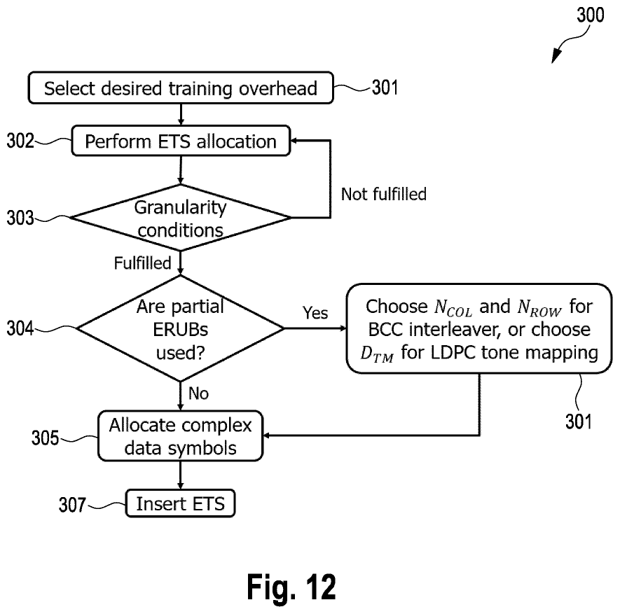

FIG. 12 shows a flow diagram of another embodiment of a first communication method 300 comprising steps that may be taken at the transmitter 10 (the first communication device) to insert ETS into the data field of a PPDU. Initially (step 301), the amount of desired training overhead is selected to balance the performance between channel estimation and data detection. Then, the allocation of ETS is performed (step 302) and granularity conditions (explained below) are checked (step 303). These steps create a blueprint of the time-frequency resources that will be reserved for ETS within the data field. If granularity conditions are not fulfilled, the process returns to step 302. Next, the allocation of complex data symbols is done (step 305) with modifications to BCC interleaver and LDPC tone mapping depending on whether partial ETS resource unit block (ERUBs) are used, which is checked in step 304. If partial ERUBS are used, in an additional step 306 N_{COL} and N_{ROW} are chosen for the BCC interleaver and DTM is chosen for the LDPC mapping. Finally (step 307), the ETSs are inserted in the time-frequency resources that have been previously reserved.

According to an embodiment one of several different granularity conditions may be used: i) the total number of ETS time-frequency resources (given by adding all subcarriers per OFDM symbol used for ETS) shall be divisible by the number of data subcarriers in a full OFDM symbol; ii) the total number of ETS time-frequency resources within an RU (given by adding all subcarriers per OFDM symbol used for ETS within the corresponding RU) shall be divisible by the number of data subcarriers in an OFDM symbol of the corresponding RU; and iii) all OFDM symbols of an RU shall be embedded with ETS.

The granularity conditions are done with respect to the ETS allocation, i.e., the condition how the ETS will be allocated in ERUBs, and how ERUBs are selected. The conditions are evaluated in terms of the number of subcarriers (counted per each OFDM symbol in the data unit) that are reserved for ETS.

There are several aspects presented in this disclosure to support ETS:
1) Selecting the number of time-frequency resources that need to be allocated for ETS.
2) The reservation of the specific time-frequency resources for ETS within the PPDU data field.
3) The design and mapping of training sequences into embedded time-frequency resources.

In the following, a detailed explanation of how ETSs are inserted into the data field of a PPDU will be given. First, aspect 1) (selection of number of time-frequency resources allocated for ETS) will be discussed.

The relationship between training overhead and performance of data reception (the latter can be measured in terms of reliability, throughput, latency, etc.) is the fundamental tradeoff that determines the number of time-frequency resources that should be allocated for ETS. To measure the training overhead, the following ratio is defined:

$${r}_{o h} = \frac{{N}_{L T F} \cdot {N}_{F F T A c t i v e} \cdot LT {F}_{T y p e} / 4 + N E T {S}_{t f}}{( {N}_{L T F} + {N}_{S Y M} ) \cdot {N}_{F F T A c t i v e}}$$

where NLTF is the number of OFDM symbols used for LTF signals, LTF_{Type} represents the type of LTF signals as one of [1,2,4] (defined in the IEEE 802.11ax standard) and indicates the proportion of active subcarriers that are used for LTF signals (this portion is calculated as LTF_{Type}/4). The number of subcarriers that are active (i.e., are not part of DC, guard, Null or pilot subcarrier sets) for each OFDM symbol is N_{FFTActive}. It depends on the resource allocation since in some cases Null subcarriers are added depending on the RU configuration, as shown in FIGS. 7 and 8. The number of data OFDM symbols is N_{SYM}. Thus, for example, the number of time-frequency resources available in N_{SYM} OFDM symbols is given by N_{SYM}·N_{FFTActive}. Finally, NETS_{tf} is the number of time-frequency resources used for ETS.

In general, the more training overhead is present, the better the channel estimation can be achieved, which in turn can increase reliability, increase throughput and/or reduce latency. However, if the training overhead is too large, the benefits of improved channel estimation become negligible compared to the loss of time-frequency resources that cannot be used for data. As a general rule for MIMO channel estimation, the optimal training overhead is positioned between 30% to 50% (i.e. 0.3≤rₒₕ≤0.5) and should not exceed 70%. Thus, a maximum value for the training overhead, denoted as rₒₕ₋ₘₐₓ, can be set based on the target performance in terms of reliability, latency and/or throughput. This yields the following bounds for the number of time-frequency resources that can be dedicated for ETS:

$$0 \leq N E T {S}_{tf} \leq N E T {S}_{tf - m ax}$$

$$where$$

$$NET {S}_{tf - m ax} = {r}_{oh - m ax} \cdot ( {N}_{L T F} + {N}_{S Y M} ) \cdot {N}_{F F T A c t i v e} - {N}_{L T F} \cdot {N}_{F F T A c t i v e} \cdot LT {F}_{T y p e} / 4.$$

This expresses a bound for the maximum amount of ETS that can be embedded in a data unit. This may be determined by the tradeoff between performance of channel estimation and available data resources. Thus, the total number of subcarriers in all OFDM symbols used for the ETS embedding is upper bounded by a metric defined as a difference between the number of subcarriers over all employed OFDM symbols, weighted by a training efficiency factor, and the total number of subcarriers used for channel estimation during the preamble.

The number of ETS time-frequency resources is set by the transmitter without knowing exactly which interference will be present during the PPDU transmission. However, during long periods of multiple frame exchanges between devices within a BSS, all devices act as transmitter and receivers at different points in time. Thus, each receiving device can collect statistical information about the interference and select an appropriate NETS_{tf} value. Moreover, a feedback mechanism can be envisioned, for example in acknowledge-ment frames, so that the receiver can inform the transmitter to increase or decrease NETS_{tf} based on the performance of data reception and/or channel estimation.

The insertion of ETS within the data field of a PPDU causes an overhead that increases the number of OFDM symbols in the data field. The encoding procedure and forward error correction (FEC) padding depend on the number of data symbols in the data field, denoted as N_{SYM}. Since the insertion of ETS does not actively involve the encoding procedure, it is desired to keep the encoding and FEC padding unchanged. Thus, the definition of data symbols N_{SYM} may be maintained as in IEEE 802.11 standard, and the following three constraints may be added to the selection of ETS time-frequency resources:
The last OFDM symbol in the data field of a PPDU shall not contain ETS.
The granularity of ETS time-frequency resources that can be added to the data field shall be done in steps amounting to the number of active data subcarriers in a full OFDM symbol. For this purpose N_{SYM-ETS} is defined as the effective number of OFDM symbols that has been added to the data field, corresponding to the insertion of ETS, and the following constraint is incorporated:

NETS_{tf}=N_{SYM-ETS}·N_{FFTActive},

or, in the case of a multi-user PPDU (MU-PPDU), the ETS granularity shall be done is steps of the number of active data subcarriers in RUs where ETS will be added.
One exception to the aforementioned conditions is when an entire RU is used for ETS. In this case, no data is present in this RU, and therefore it does not affect the data encoding process. The only condition is that the number of OFDM symbols in this RU does not exceed the one in other RUs containing data.

As a result, all transmitter blocks to the left of, and including, the stream parser block 57 in the diagram shown in FIG. 5 may remain unaffected by the ETS insertion.

Next, aspect 2) (reservation of the specific time-frequency resources for ETS within the PPDU data field) will be discussed. The effective use of ETS requires that interference is present on the time-frequency resources where ETS are located. The reservation of the specific time-frequency resources for ETS depends on how much knowledge the transmitter has about the type of interference that can affect the communication system.

After the transmitter and receiver have exchanged some frames, or after carrier clear assessment (CCA) has been performed, it is possible for both of them to identify the type of interference that is present in their communications: for example, if the interference tends to occur within certain bandwidth that overlaps with the current communication, or whether it comes in short bursts with certain period, or the interference channel contains strong time-varying components, or it has certain spatial characteristics like a certain number of strong spatial streams, or all combined.

It is possible that there is no predictable pattern detected in previous frame exchanges, or even if there is, it does not guarantee that the interference will follow the same pattern during future transmissions. However, knowledge from interference patterns can be applied more consistently in controlled spatial reuse cases with one or more BSS, or in cases of adjacent channel leakage from other WLAN transmissions.

In the following, embodiments of solutions on how to allocate the ETS time-frequency resources to enable dynamic interference suppression will be discussed. After that, receiver aspects will be elaborated, and it will be explained how the devices can estimate the type of interference.

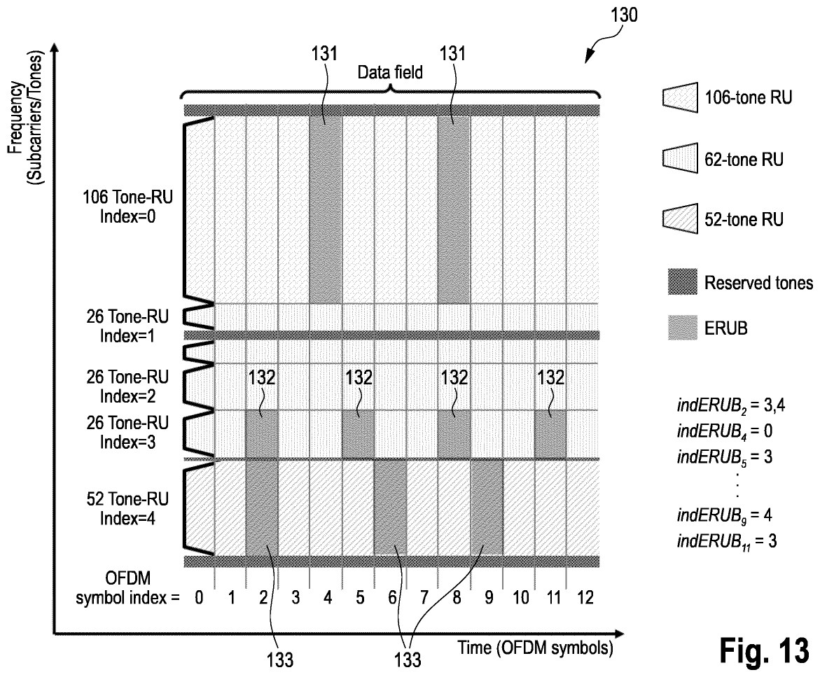

An ETS Resource unit block (ERUB) will be explained first. Due to the dynamic nature of interference, the ETS time-frequency resource reservation should be flexible. However, more flexibility also results in more complexity of implementation and signaling. Thus, an ETS resource unit block (ERUB) is defined to allocate the ETS in frequency blocks of the same size as the RUs, but with a time duration of one OFDM symbol as shown in FIG. 13 showing a diagram of a data field 130 of a PPDU into which multiple ERUBs 131, 132, 133 are allocated to various RUs, thus illustrating an example of ERUB allocation. This ERUB definition allows for a frequency allocation in the same way as RUs, which reduces implementation complexity, while adding flexibility by enabling a time allocation in an OFDM symbol basis.

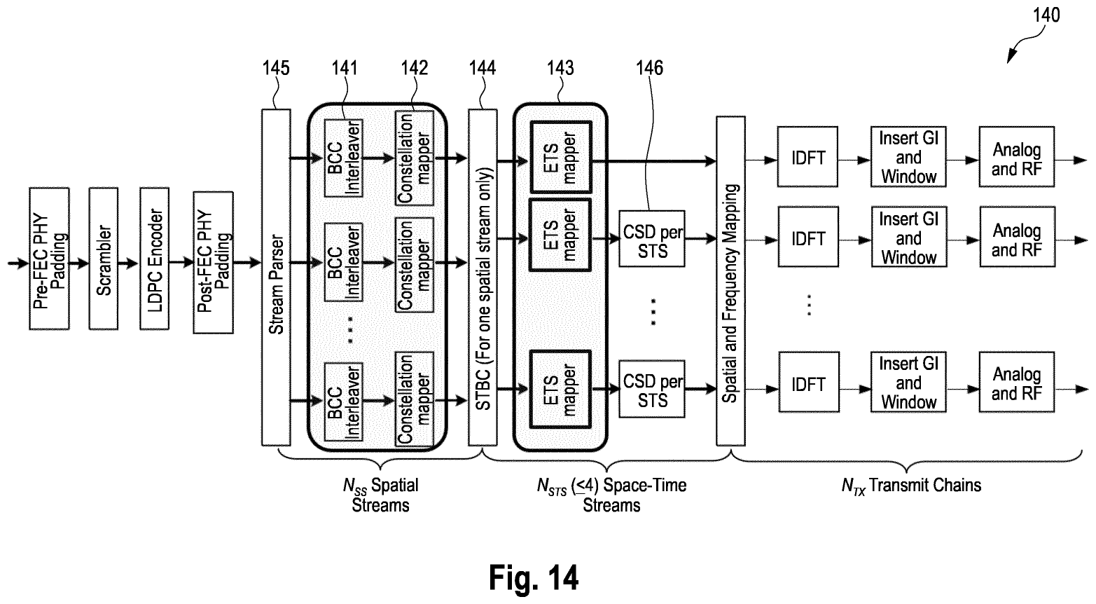

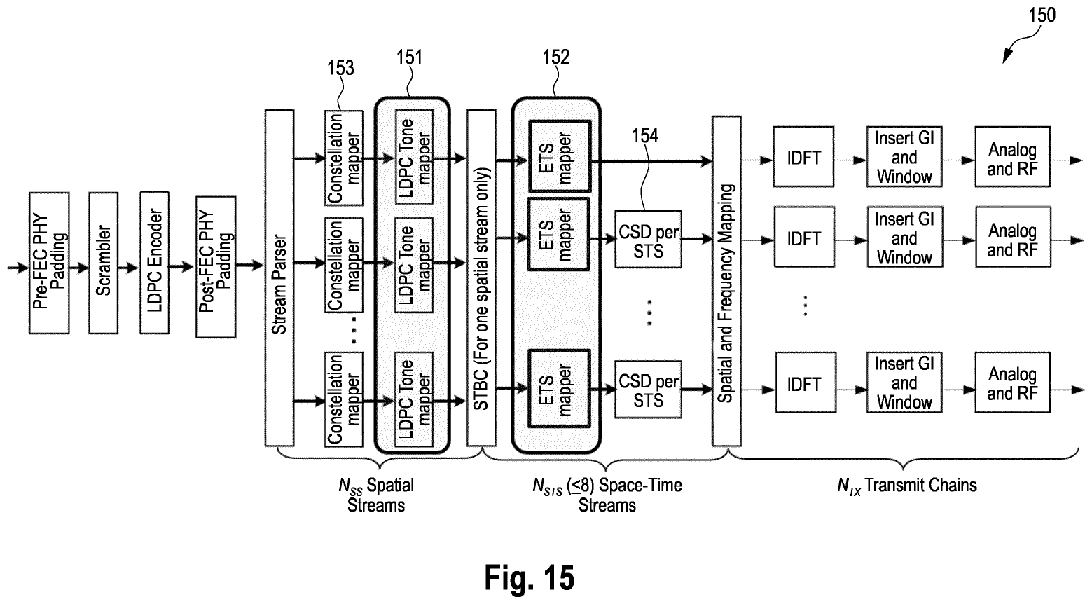

To implement the insertion of ERUBs, the transmitter for uplink and/or downlink transmission of the Data field may need to be modified. This is illustrated in FIGS. 14 and 15 showing schematic diagrams of further embodiments 140, 150 of the first communication device for the cases for BCC encoding (FIG. 14) and LDPC encoding (FIG. 15), respectively. The affected blocks are highlighted in these figures: for BCC encoding the BCC interleavers 141, constellation mappers 142 and ETS mappers 143 may be affected, and for LDPC encoding the LDPC tone mappers 151 and ETS mappers 152 may be affected.

In the following, it will be explained where the modifications take place within the transmitter and how these modifications are done. In the case of BCC encoding (FIG. 14), the constellation mapper block 142 can be modified to reserve subcarriers (e.g. leave them unused) when performing the mapping between the complex modulated data symbols and subcarriers for a given OFDM symbol. The reserved subcarriers accommodate ETS and/or ERUB. This modification would take place when an ERUB is being transmitted within the data field. Depending on how the reservation of subcarriers in done, the BCC interleavers 141 may also need modifications. In the case of LDPC encoding (FIG. 15), the LDPC tone mapper block 151 performs the task of mapping complex modulated data symbols from the constellation mapper block 153 into the corresponding subcarriers within a given RU. To reserve ETS subcarriers in the case of an ERUB, the LDPC tone mapper block 151 (which may be implemented in the form of an LDPC interleaver) may need to be modified.

Another variant is to have a unified implementation where the LDPC tone mapper 151 is kept as a general block, denoted as tone mapper, for both BCC and LDPC encoding. This implies that in the BCC encoding case, the constellation mapper 141 may not need to be modified, and the tone mapper block is added to the right of the constellation mapper 142 (left of the space time block coding (STBC)) block 144 in FIG. 14. This variant would require the tone mapper to operate differently for BCC and LDPC encoding.

The ETS mapper 143, 152 is a new block that performs the task of inserting the ETS in the previously reserved subcarriers. To support the reservation of time-frequency resources for ETS using the definition of ERUB, there are two main mechanisms: a) the allocation of ERUBs within the data field of a PPDU, and b) the allocation of ETS within each ERUB. In the following each mechanism will be defined and it will be explained how to implement them.

First, mechanism a) (allocation of ERUBs with a PPDU's data field) will be explained. The ERUB allocation is preferably done in the time and/or frequency domain. In the case of frequency allocation, the ERUB sizes (i.e. number of subcarriers or tones contained within a ERUB) follow the same definition as the RUs in the IEEE 802.11ax standard (as shown e.g. in FIGS. 7 and 8) where there are many configurations available to divide the PPDU bandwidth into RUs of different sizes. This provides the means of selecting the size and location of ERUBs without adding complexity to the standardized operation.

In the case of time allocation for ERUBs, an identifier, e.g. denoted as indERUBₙ, is defined that contains the location of the RUs that will be replaced by ERUBs in the n^{th} OFDM symbol of the data field, as shown in FIG. 13. If an OFDM symbol does not contain ERUBs, then indERUBₙ is not defined (or left empty) for that symbol. This identifier can be built in a customized way to select specific OFDM symbols like in the example of the two ERUBs in the 106-tone RU shown in FIG. 13. However, this may add some implementation complexity and signaling overhead. Another alternative to reduce complexity, is to build the identifier based on a standardized pattern, for example one ERUB every fixed number of OFDM symbols, like in the example of the four ERUBs that are placed every third OFDM symbol in the 26-tone RU shown in FIG. 13.

In an embodiment a granularity condition for the total number of time-frequency resources used for ETS, that is, the total number of subcarriers in all ERUBs defined in the data field of a PPDU must be an integer multiple of N_{FFTActive} is respected. This can be defined in mathematical terms as

$${\sum }_{n} {\sum }_{r ∈ {indERUB}_{n}} N E T {S}_{r , n} = {N}_{S Y M - E T S} \cdot {N}_{F F T A c t i v e}$$

where NETS_{r,n} is the number of subcarriers allocated to ETS in the r^{th} ERUB of the n^{th} OFDM symbol. The double summation on the left-hand-side of the equation above equates the total number of time-frequency resources used for ETS, denoted as NETS_{tf}. If all subcarriers of each ERUB are dedicated to ETS, that is NETS_{r,n} is equal to the number of data subcarriers defined in the r^{th} RU for all tuples (r, n), then N_{SYM-ETS}=2 in the embodiment shown in FIG. 13. A similar condition can be used for the case of a MU-PPDU where the granularity is done in terms of the number of active subcarriers per RU.

The selection of indERUBₙ, depends on the amount of knowledge that the transmitter has about the type of interference. In case the interference in likely to affect a part of the PPDU bandwidth, the RUs overlapping with this bandwidth can be selected to have more ERUBs compared to the rest. If the interference has a specific periodicity or a coherence time shorter than that of the intended channels, the selection of OFDM symbols having ERUBs can be adapted to these time structures. More comprehensive examples are given below.

In each PPDU, the receiver shall know which RU within an OFDM symbol corresponds to an ERUB in order to properly interpret the ETS content. In a first step it may be indicated whether the transmitted PPDU contains ERUBs or not. This can be done with only one bit or as part of an ERUB type field. For example, a one-bit flag can be added to the common info field HE-SIG-A (as defined in IEEE 802.11ax) to indicate if ERUBs are present or not. The locations of the ERUBs can be signaled by one of the following options:

According to one option fixed standardized patterns for the locations of ERUBs within a PPDU may be defined, in which case the transmitter would only need to include information about which pattern is being used. This would be useful for a case where the transmitter does not know the interference type (e.g., at the beginning of a frame exchange).

According to another option an ETS allocation field may be defined within the SIG field of the PPDU header containing the information on indERUBₙ. This can be used to adapt the ERUB allocation to a type of interference based on knowledge at the receiver. As an example, a specific STA_ID address can be defined and used in the HE-SIG-B field to indicate the locations of ERUBs in the frequency domain. Then, for this specific STA_ID, the locations of ERUBs in the time domain if present (indexing the OFDM symbols) can be added in the user specific field. This example is well suited for the case of full ETS ERUBs that will be explained below.

According to still another option it may be indicated whether a suggestion made by the receiver (in a previous frame exchange) for the ERUB allocation is being adopted. In this case it is assumed that the receiver has successfully obtained feedback information about a suggested ERUB allocation.

In another embodiment signaling may be provided to indicate how the allocation of ETS is done within the ERUBs. In the following several types of ERUBs will be defined, and for each type the signaling needed is different. Thus, as first step it may be useful to signal which type of ERUB is being used. The specific signaling needed to support each ERUB type is will now be explained.

Now, mechanism b) (allocation of ETS within ERUBs) will be explained. The RUs sizes and configurations are primarily designed to enable OFDMA operation which means that the RU sizes may be set by the OFDMA resource allocation in a given PPDU. As a result, it may not always be possible to choose the size of the ERUBs. For example, assuming that an access point (AP) wants to transmit data to five STAs simultaneously using OFDMA and has selected the resource configuration shown in FIG. 13 to optimally match the communication requirements of each STA with a corresponding RU. In this case, it is not desired for the AP to change the RU configuration to enable different ERUB sizes. Thus, the allocation of ETS within each ERUBs will add flexibility for the interference suppression.

The following cases define different types of ERUBs showing mechanisms to reserve ETS subcarriers. In a first case full ETS ERUB is considered. In this case the entire ERUB is reserved for ETS (except for pilot subcarriers). This simplifies the implementation since there is no need to define a tone mapping operation and enables channel estimation for all subcarriers in the RU at the particular point in time that the ERUB is placed. Here, the number of ETS in each ERUB is given by

$$N E T {S}_{r , n} = \{ \begin{matrix}\begin{matrix}{N}_{SRU , r} - {N}_{SP , r} & if r ∈ {indERUB}_{n}\end{matrix} \\ \begin{matrix}0 & otherwise\end{matrix}\end{matrix}$$

where N_{SRU,r} and N_{SP,r} are the number of active and pilot subcarriers in the r^{th} RU, respectively. The cost of such a simplified implementation is that flexibility for ETS allocation may be lost, leaving less room to control of the training overhead.

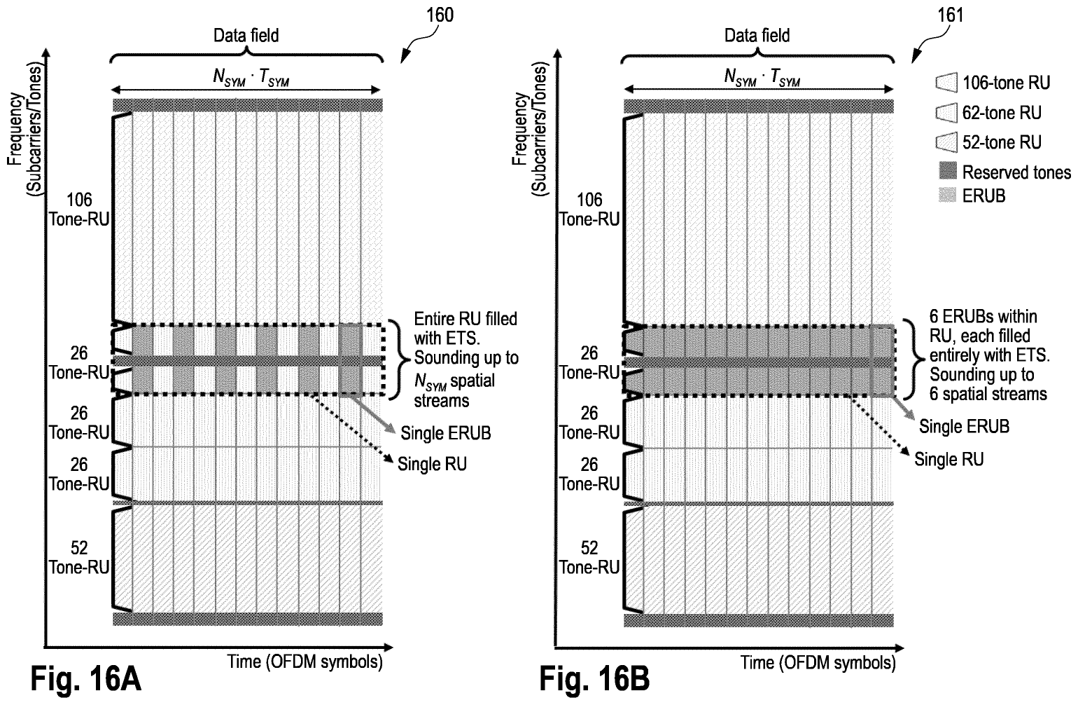

Apart from enabling interference suppression, full ETS ERUBs can be used to enable channel sounding within the data field of a PPDU. Channel sounding is a procedure in which the transmitter collects channel information to configure its beamforming weights, which is done in the spatial (and frequency) mapping block of the transmitter illustrated in FIGS. 14 and 15. For this application, it is necessary to have several ERUBs aligned in the frequency domain, amounting at least to the number of spatial streams that need to be sounded. FIG. 16 shows diagrams of two examples of full ETS ERUB utilization. FIG. 16A shows an example of a data field 160 of a PPDU where an entire 26 tone RU is filled with ETS, whereas FIG. 16B shows an example of a data field 161 of a PPDU where 6 ERUBs within the 26 tone RU are each entirely filled with ETS. An important selection of indERUBₙ is such that a RU is occupied for the entire PPDU's data field as shown at the top of FIG. 16.

To signal the use of full ERUB, little overhead is needed since it is only necessary for the receiver to know the location of the ERUBs. This has already been explained above.

In a second case half ETS ERUB is considered. In this case only half of the ERUB is reserved for ETS and the other half is used for complex modulated data symbols. To enable this operation with limited complexity the DCM scheme may be used as a baseline to map the complex modulated data symbols to only half of the ERUB. In the following the changes needed along the transmitter block diagram to support the ETS insertion will be explained.

For the BCC encoding shown in FIG. 14, after the stream parser block 145, a stream of encoded bits per each spatial stream is fed into the BCC interleaver block 141. The BCC interleaver operation performs permutations of the encoded bits that provide frequency diversity to increase reliability. These permutations are performed by dividing the bits into blocks which are filled in rows and read out in columns of size N_{ROW} and N_{COL} respectively. The values taken by these parameters are well defined in the standard. In particular, for the DCM operation, the N_{COL} and N_{ROW} values are defined for half of the size of the RUs, since in DCM operation the data symbols are duplicated in each RU. Thus, to include ETS in half of an ERUB, the N_{COL} and N_{ROW} values can be taken directly from the DCM implementation and the BCC interleaver 145 would not require any modifications. Then, in the constellation mapper 142 half of the subcarriers in the ERUB can be left empty instead of duplicating the data (as it would be done with DCM), and insert ETS at the ETS mapper block 143. Alternatively, an additional tone mapping operation may be added to distribute the complex data symbols into corresponding subcarriers based on a ETS allocation strategy, as shown in FIG. 17.

For the LDPC encoding shown in FIG. 15, after the constellation mapper 153 the complex modulated symbols containing the encoded data are fed into the LDPC tone mapper 151. This block performs a permutation to the stream of complex data symbols to spread them throughout the subcarriers within the RU. This introduces frequency diversity that can increase reliability. The exact LDPC tone mapping operation is done with a fixed mapping distance that is well defined in the standard. In particular, for DCM operation, this distance enables the separate mapping of the subcarriers in two halves of the RU. Thus, a simplified insertion of ETS within an ERUB is to use the LDPC tone mapping as in the DCM operation but instead of duplicating the data, leaving one of the ERUB halves reserved for ETS. Then, the ETS mapper 152 inserts the ETS in the previously reserved subcarriers.

There are two operations done by the LDPC tone mapper 151. First, the complex data symbols are permuted with a standardized mapping distance, and second, the permuted complex data symbols are mapped into the subcarriers within the RU. By utilizing the DCM framework, the first operation (permutation of complex symbols) is left unchanged. In the case that a custom ETS tone mapping is desired, a further modification to the second operation (mapping between permuted complex symbols and subcarriers) may be done. This corresponds to the customized tone mapping operation explained below.

FIG. 17 shows three diagrams 171, 172, 173 illustrating different ETS allocation strategies that can be applied in the case of BCC or LDPC. Here, the end results of the ERUB resource allocation is shown after all steps to the left of the CSD (146 in FIG. 14, 154 in FIG. 15) have been taken.

Next, a customized tone mapping operation will be explained. As mentioned above for the case of BCC and LDPC encoding, an extra degree of flexibility for the ETS allocation requires an additional tone mapping operation to allocate the complex data symbols into the subcarriers of an ERUB. This tone mapping operation refers to the allocation of complex data symbols into the subcarriers and not to the permutation operations defined in the BCC interleaver or LDPC tone mapping. The latter operations are implemented in the same way as specified by the DCM scheme with the difference that only half of the subcarriers may be used for complex data symbols. The other half may be used for ETS instead of duplicated symbols as it would be in the regular DCM operation. Thus, the additional tone mapping operation to reserve ETS subcarriers in an ERUB, is defined as

$${d}_{f ( k ) , n}^{′} = {d}_{k , n} , \{ \begin{matrix}k = 0 , 1 , … , {N}_{SD , r} - 1 \\ n = 0 , 1 , … , {N}_{SYM} - 1\end{matrix}$$

$${N}_{SD , r} = ( {N}_{SRU , r} - {N}_{SP , r} ) / 2$$

where N_{SD,r} is the number data subcarriers in the r^{th} RU which in this case is half the active subcarriers in the RU. The complex data symbols are denoted as d_{k,n} and f(k) is a function that performs the additional tone mapping. The complex data symbols at the output of the tone mapping operation, denoted as d′_{f(k),n}, are then located in specific subcarriers leaving reserved ones for ETS following a specific strategy. The main principle shown in the equa-tions above is to map the N_{SD,r} data symbols into subcarriers by following a particular pattern to for example spread the data evenly in the ERUB or restricted to a specific group of subcarriers.

In FIG. 17, two examples 172, 173 for custom tone mapping are defined for a 26 tone ERUB, where k′=0,1, . . . , N_{SRU,r}−1 corresponds to the tone index in the entire RU and Kₚᵢₗₒₜ is the set of subcarriers used for pilots.

It is worth mentioning that the tone mapping function f(k) can also be implemented by defining a set of subcarriers that are not allocated for either ETS or pilots. An example is given in the next case for partial ETS ERUB explained below.

The signaling needed to support the use of half ETS ERUB depends on the tone mapping used. When the default DCM mapping is used, it is only necessary to signal whether the upper or lower half of the subcarriers in the RU are used for ETS. When a custom tone mapping is used, one of the following mechanisms can be used: a) a standardized pattern can be defined and the signaling only indicates which pattern is being used; b) the specific tone mapping for ETS subcarriers (e.g., the set K_{ETS}) can be sent in the SIG field of the PPDU. In case the receiver suggests a specific tone mapping, the transmitter may indicate if the previous suggestion is being used in the current PPDU.

In a third case partial ETS ERUB is considered. In this case the number of ETS in an ERUB can be set to any integer value to allow full flexibility. This is especially useful in single-user PPDUs or multi-user PPDUs with large RUs. However, the additional flexibility comes with a cost on complexity. To enable partial ETS ERUBs, the permutation operations of the BCC interleaver or LDPC tone mapper may be modified to account for the non-standard number of data subcarriers in the ERUB. For the BCC interleaver 141, this means to define custom N_{COL} and N_{ROW} sizes are respective permutation operations. For the LDPC tone mapper 151, a custom permutation operation and mapping distance are introduced. Their main purpose is to spread the encoded bits in the frequency domain to gain diversity and increase reliability.

Alternatively, to reduce complexity, since the most beneficial use case of partial ETS ERUB is when the RU size is large, the permutation and tone mapping operations of BCC and LDPC encoding defined for smaller size RUs may be reused. the BCC and LDPC encoding cases shall be considered separately.

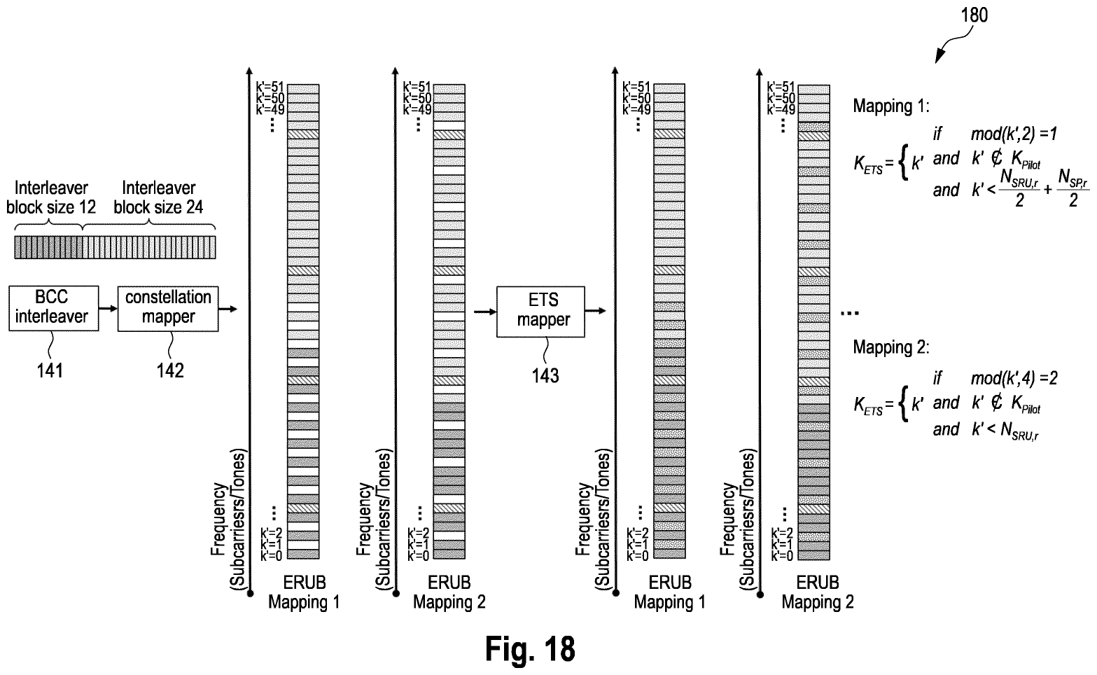

For BCC encoding the minimum block size for the BCC interleaver operation corresponds to 12 subcarriers when DCM operation is used in a 26-tone RU, and block sizes of 24, 48, 51, 102, 117, and 234 are also supported. Each one of these block sizes is used only for a specific RU size and DCM configuration. To enable partial ETS ERUB with limited complexity, the BCC interleaver 141 can be implemented with one or several of the aforementioned standardized block sizes, while performing a customized tone mapping to partially fill the ERUB with complex data symbols. In this case, for instance a 52 tone ERUB may be filled with two data blocks, one of size 12 and another of size 24, leaving 12 subcarriers free for ETS. The remainder four subcarriers may be reserved for pilots. FIG. 18 shows a diagram illustrating partial ETS allocation 180 in a 52-tone EURB for BCC encoding.

The tone mapping operation is done by first defining a set with the location of ETS subcarriers, denoted as K_{ETS}, and then allocating the complex data symbols to the subcarriers that are not reserved for either ETS or pilots. This means that

$$f ( k ) = {K}_{data , k}$$

$$\begin{matrix}{K}_{data} = \{ {k}^{′} : {k}^{′} = 0 , … , {N}_{SRU , r} - 1 , & {k}^{′} ∉ {K}_{P i l o t} ⋃ {k}^{′} ∉ {K}_{E T S} \}\end{matrix}$$

where K_{data} defines the set of data subcarriers in the ERUB, and K_{data,k} corresponds to the k^{th} index in the set K_{data}.

For LDPC encoding the first part of the LDPC tone mapping performs a standardized permutation operation on the complex data symbols, given by

$${d}_{t ( k ) , n}^{′} = {d}_{k , n} , \{ \begin{matrix}k = 0 , 1 , … , {N}_{SD , r} - 1 \\ n = 0 , 1 , … , {N}_{SYM} - 1\end{matrix}$$

$$t ( k ) = {D}_{T M} \cdot mod ( k , \frac{{N}_{SD , r}}{{D}_{T M}} )$$

where the parameter D_{TM} corresponds to the tone mapping distance and it is defined in the standard specifically for each RU with and without the DCM operation. The key character-istic of the D_{TM} value is that it needs to divide the number of data subcarriers in a RU by an integer number. That is, for a 52-tone RU with 48 data subcarriers D_{TM}=3 divides the data subcarriers into blocks of 16. Similarly, for a 106-tone RU with 102 data subcarriers D_{TM}=6 divides the data subcarriers into blocks of 17. To enable partial ETS ERUB with limited complexity, the standardized LDPC tone mapping permutation may be reused and the values of D_{TM} may be changed accordingly to divide the number of data subcarriers into integer blocks. In the standard operation, the D_{TM} values are fixed for each RU size. Thus, to implement partial ETS ERUBs, first the number of ETS that will be added in the ERUB are defined, and second, a D_{TM} value is selected that divides the remainder data subcarriers in the ERUB. For example, if 8 ETS shall be added to a 52-tone ERUB, the resulting number data subcarriers would be 40 (accounting for 4 pilot subcarriers). The standard D_{TM} value for a 52-tone RU is 3 which does not divide 40. Thus, the D_{TM} value may be changed to 4. Another possibility would be to select the number of ETS that would enable the resulting data subcarriers to be divisible by the standard D_{TM} value. For example, taking 12 ETS from a 52-tone ERUB resulting in 36 data subcarriers that are divisible by the standard D_{TM} value of 3. In terms of signaling, the transmitter using partial ETS ERUB specifies the number of ETS within the ERUB and the tone mapping operation. In the case of BCC encoding the block sizes for the BCC interleaver may be shared, and for LDPC encoding the LDPC tone mapper operation may be shared as well.

Similarly, as in previous cases, these parameters can be pre-defined in standardized patterns or explicitly signaled in the SIG fields of the PPDU. When the standardized BCC interleaver blocks and LDPC tone mapping operation are used, then the transmitter may indicate which block sizes are being used (for BCC) or the D_{TM} parameter (for LDPC). It is also possible for the receiver to feedback a specific configuration. In this case the transmitter may indicate if the suggested configuration is used in the current PPDU or not.

Next, aspect 3) (the design and mapping of training sequences into embedded time-frequency resources) will be discussed.

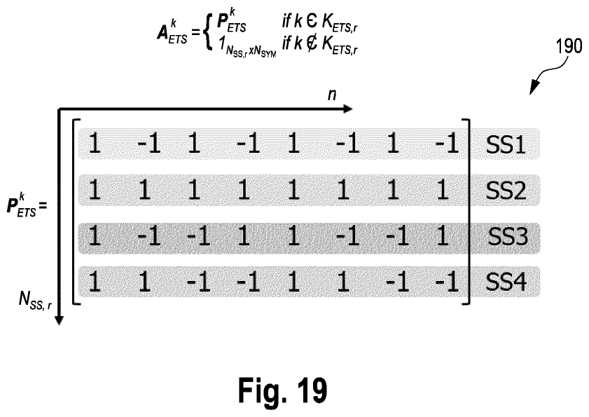

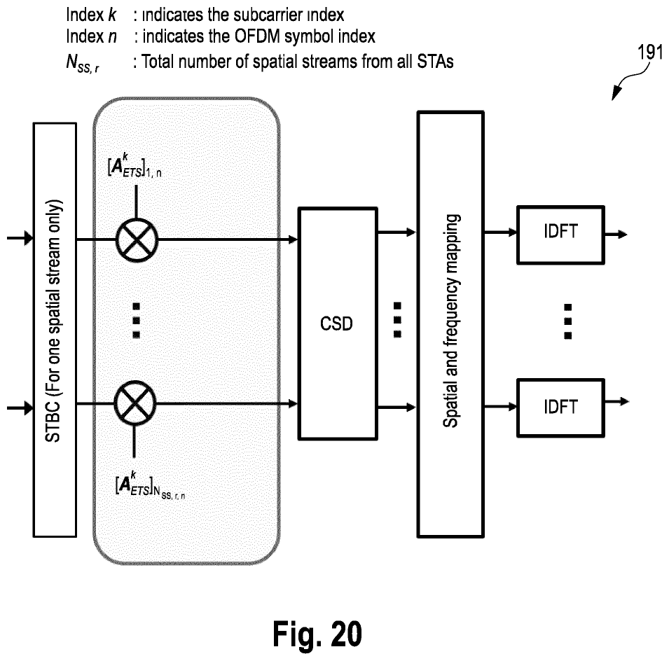

The insertion of the ETS sequences takes place at the ETS mapper block 143, 152 shown in FIGS. 14 and 15. This operation can be implemented in a similar way as for the LTF generation in the IEEE 802.11ax standard where the complex modulated symbols at the output of constellation mapper or LDPC tone mapper block (depending on the encoding type) are multiplied by a mapping matrix 190, denoted as P_{ETS}^{k}, in the subcarrier locations reserved for ETS, as shown in FIG. 19. For the subcarriers allocated to pilot and data, the ETS mapper does not modify their content, as exemplified in FIG. 19 by multiplying with ones. FIG. 20 shows a schematic diagram illustrating ETS mapper operation 191 for ERUBs included in 8 OFDM symbols.

The design of the ETS mapping matrix P_{ETS}^{k} depends on the desired application. For the main application described in this disclosure (i.e., interference suppression) the key in to obtain observations of the interference. This can be done by simply leaving the reserved ETS subcarriers in ERUBs empty, i.e., P_{ETS}^{k}=0, or, place sequences that allow for the re-moval of the intended signal. For example, in case of a row of a matrix with orthogonal rows (e.g., DFT or Hadamard matrix), the receiver can project with the unused rows and get the interference observations. This requires the P_{ETS}^{k} matrix to have more columns than rows in order to have unused rows. Alternatively, the channel estimates in the LTFs can be used to subtract the transmitted signals and no specific requirement on the size of P_{ETS}^{k} is needed.

The ETS mapping matrix contains the elements of the ETS itself. A multiplication operation is an example in which a reserved subcarrier at a specific ERUB can be assigned an element of the ETS mapping matrix, here the interpretation of a reserved subcarrier would be a one. If it is assumed that the implementation multiplies all subcarriers in an ERUB with a value, then the data subcarriers are multiplied with a one to avoid making changes to the data.

Another application of ETS, is to improve estimates of intended channels which can be done at the receiver by doing a weighted average of the channel estimates in the LTF with the channel estimates obtained from the ETS observations. This averaging may be performed for channel estimates that come from the same or neighboring subcarriers, to account for the intended coherence bandwidth. In this case the rows of the P_{ETS}^{k} matrix shall be orthogonal and there shall at least be as many rows as number of spatial streams. This P_{ETS}^{k} matrix implementation also may be used to perform channel sounding at the receiver when full ETS ERUBs are used.

FIG. 19 shows an example where a P_{ETS}^{k} matrix with 4 orthogonal rows is used to improve the channel estimates of 4 spatial streams. Furthermore, the P_{ETS}^{k} matrix has 8 columns which means that there are 4 unused rows and the receiver can project the received signal in the corresponding ETS locations with the unused rows to estimate 4 interference spatial streams.

In terms of signaling, the receiver should know the P_{ETS}^{k} matrix and the rows used for each spatial stream at the transmitter to insert the ETS. This can be selected as a standardized parameter, similar to the case of the R_{HE-LTF} matrix in the IEEE 802.11ax standard.

In the following, receiver aspects will be explained. The receiver is assumed to know the location of the ETS within the data field of the PPDU, since this has been signaled in the PPDU header as described above. For the pilot subcarriers the receiver processing is not changed. For the data subcarriers, only a change in the MIMO spatial filter can be added based on channel estimates obtained from ETS. However, the processing of data itself is left unchanged.

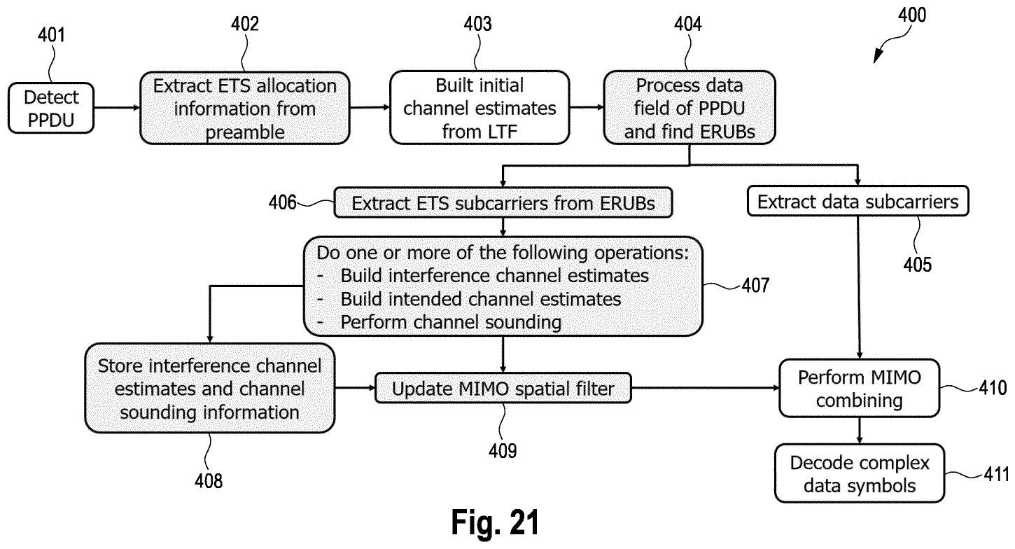

FIG. 21 shows a flow chart of another embodiment of a method 400 of the receiver processing to decode a PPDU with ETS. In a first step 401 a PPDU is detected. In a second step 402 ETS allocation information is extracted from the preamble of the PPDU. In a third step 403 initial channel estimates are built from the LTF (in the preamble). In a fourth step 404 the data field of the PPDU is processed and the ERUBs are found. In a fifth step 405 data subcarriers are extracted and in a sixth step 406 ETS subcarriers are extracted from the ERUBs. In a seventh step 407 one or more of the following operations is done: build interference channel estimates, build intended channel estimates and perform channel sounding. In an eighth step 408 interference channel estimates and channel sounding information are stored. In a ninth step 409 a MIMO spatial filter is updated. In a tenth step 410 MIMO combining (also referred to as MIMO equalizing) is performed using the results of steps 405 and 409. In an eleventh step 411 complex data symbols are decoded.

The processing of the signal observations obtained from ETS subcarriers depends on the design of ETS and the desired application. In case the main application is interference suppression, the receiver may extract interference channel estimates from the ETS signal observations. This depends on the ETS design: If the ETS are selected to be zeros, then the signal observations are directly taken as the interference channel estimates with some appropriate scaling factor. If the ETS are selected to be a specific sequence, then the interference channel estimates are obtained by performing an orthogonal projecting to the signal observations with the unused rows of the P_{ETS}^{k} matrix. Alternatively, the intended channel estimated from the LTF can be used to subtract the intended channels from the ETS signal observations. The remainder corresponds to the interference channel estimates with some appropriate scaling factor. After extracting the interference channel estimates, the MIMO spatial filter can be updated to suppress the interference effect.

The receiver can also store the interference channel estimates or ETS signal observations to do a more comprehensive statistical processing to estimate the type of interference (more details will be shown below).

In case the ETS are used to improve channel estimation, the ETS signal observations may be processed to extract the intended channels corresponding to the number of intended spatial streams. This may be done by multiplying the ETS signal observations with values of the P_{ETS}^{k} matrix rows that correspond to each intended spatial stream. The resulting intended channel estimates from ETS can also be merged with the LTF channel estimates by performing a weighted averaging operation. To improve intended channel estimation, the ETS signal observations may be taken from the same or neighboring subcarriers to account for the coherence bandwidth of the intended channels.

In case the ETS are used to perform channel sounding, ETS signal observations from several ERUBs may be combined in order to get as many observations per subcarriers as number of spatial streams that need to be sounded. The combined observations are then projected with corresponding rows of the P_{ETS}^{k} matrix to estimate the channel for each intended spatial stream. Then, matrix decomposition techniques like singular value decomposition can be used to extract the beamforming weights.

In the following it will be explained how the devices can estimate the type of interference, and solutions on how to allocate the ETS time-frequency resources accordingly will be presented. To determine the type of interference, the receiver device can do a statistical analysis of the interference channels observed in the ETS of several received PPDUs. Within a BSS, during several exchange of frames between devices, these devices may act as transmitter and receiver at different points in time, giving them the opportunity to collect statistical information about the interference.

To estimate a frequency structure within the interference, the receiver can compare the average interference energy detected in subcarriers that occupy different frequencies and detect significant changes (e.g., the average energy changes in the order of 5 dB or above). In addition, the ETS can be used to estimate the coherence bandwidth of interference signals (i.e., the bandwidth during which the interference channel remains almost flat). This coherence bandwidth can be estimated by computing the auto-correlation between ETS received at different subcarriers, and obtaining the frequency lag after which the auto-correlation lowers below a threshold (e.g., typically high correlation is considered for values above 0.8 of the auto-correlation function).

To estimate a time structure within the interference, the receiver can compare the average interference energy detected during specific OFDM symbols and detect significant changes. From this comparison, the receiver can detect if there are certain periodic patterns in the interference and/or if the interference channel changes rapidly compared to the time variation of the intended channel. For example, If the interference occurs in bursts that are recurrent, their period can be roughly estimated by measuring the time between interference energy peaks from ETS in previous PPDUs and making a statistical combination of them (e.g. weighted average). In case the interference channel has strong time-varying components, the coherence time (i.e., the time during which the variations of the channel are small) can be estimated by computing the auto-correlation between ETS received at different OFDM symbols, and obtaining the time lag after which the auto-correlation drops below a threshold (e.g., typically, values above 0.8 can be considered as having high correlation).

Regarding the spatial structure, the maximum number of spatial streams that the receiver can distinguish is limited by the number of receive antennas it has. By taking the same or more interference observations from received ETS than the number of received antennas, the receiver can apply known methods of matrix decomposition (e.g. Eigen value decomposition or singular value decomposition) and estimate how many strong channel direc-tions (equivalent to spatial streams) are present in the interference. This can be done by comparing for example the magnitude of the eigenvalues or singular values after conducting the matrix decomposition. For example, the number of interference spatial streams may be the number of Eigen or singular values for which more than 80% of the energy in the samples is found.

In summary, the present disclosure focusses on the general concept of embedding ETSs into the data field of a PPDU, in particular into ERUBs. This is not known in the prior art, which make use of midambles and pilot subcarriers. The use of midambles includes inserting copies of the entire long training field (LTF) in the middle of the data field. Key difference with the present disclosure is flexibility: according to the concept of the present disclosure, OFDM symbols can be mixed with data and training, i.e., a group of subcarriers in an OFDM symbol can be used for data and others for ETS. Further, if there is an OFDM symbol with only ETS, is does not need to be the same as in the LTF. Pilot subcarriers are fixed subcarriers used for phase and frequency tracking. Key difference with the present disclosure is again flexibility: The locations of pilot subcarriers are fixed for all OFDM symbols in the PPDU, their locations are too sparse in the frequency domain (which does not allow effective channel estimation), and their design is for parameter tracking and not channel estimation.

The present disclosure presents solutions that enable channel estimation and suppression of dynamic interference in the data field of a PPDU via MIMO processing, provide the abil-ity to track changes in wireless channels, improve channel estimation and reliability of intended communications, and enable channel sounding within the data field of a PPDU while adding a small overhead.

Thus, the foregoing discussion discloses and describes merely exemplary embodiments of the present disclosure. As will be understood by those skilled in the art, the present disclosure may be embodied in other specific forms without departing from the spirit or essential characteristics thereof. Accordingly, the disclosure of the present disclosure is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

In the claims, the word “comprising” does not exclude other elements or steps, and the in-definite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure. Further, such a software may also be distrib-uted in other forms, such as via the Internet or other wired or wireless telecommunication systems.

The elements of the disclosed devices, apparatus and systems may be implemented by corresponding hardware and/or software elements, for instance appropriated circuits or circuitry. A circuit is a structural assemblage of electronic components including conven-tional circuit elements, integrated circuits including application specific integrated circuits, standard integrated circuits, application specific standard products, and field programma-ble gate arrays. Further, a circuit includes central processing units, graphics processing units, and microprocessors which are programmed or configured according to software code. A circuit does not include pure software, although a circuit includes the above-described hardware executing software. A circuit or circuitry may be implemented by a single device or unit or multiple devices or units, or chipset(s), or processor(s).

It follows a list of further embodiments of the disclosed subject matter:

1. First communication device configured to transmit data to a second communication device, the first communication device comprising circuitry configured to:
generate a number of one or more spatial streams, each spatial stream carrying payload data;
map the payload data of each of the one or more spatial streams into a data field of a data unit, wherein a data unit comprises a preamble and a data field carrying one or more OFDM symbols and wherein one or more resource units (RU) are allocated to a data unit;
reserve one or more subcarriers within one or more embedded training sequences (ETS) RU blocks (ERUBs) in one or more OFDM symbols in the data field of a data unit, wherein an ERUB spans part of or the complete bandwidth of a RU; and embed one or more ETSs into the one or more reserved subcarriers within one or more ERUBs.

2. First communication device as defined in embodiment 1, wherein the processing circuitry is configured to determine the amount of ETSs to be embedded into a data field of a data unit.

3. First communication device as defined in embodiment 2, wherein the processing circuitry is configured to determine the amount of ETSs so that the total number of subcarriers in all OFDM symbols used for the ETS embedding is upper bounded by a metric defined as a difference between the number of subcarriers over all employed OFDM symbols, weighted by a training efficiency factor, and the total number of subcarriers used for channel estimation during the preamble.

4 First communication device as defined in embodiment 2 or 3, wherein the processing circuitry is configured to determine the amount of ETSs to be embedded into a data field of a data unit based on information about interference collected by the first communication device and/or the second communication device and/or an instruction to increase or decrease the amount.

5. First communication device as defined in any one of the preceding embodiments, wherein the processing circuitry is configured to not to embed ETSs in the last OFDM symbol carried in a data field.

6. First communication device as defined in any one of the preceding embodiments, wherein the processing circuitry is configured to check, before mapping payload data into a data field of a data unit, if one or more granularity conditions with respect to the spatial streams are fulfilled once the one or more ETSs are embedded.

7. First communication device as defined in embodiment 6, wherein the processing circuitry is configured to check, as granularity condition, if
the total number of subcarriers in all the OFDM symbols used for ETS embedded inside a data field is divisible by the number of data subcarriers of an OFDM symbol for which no ETS embedding is performed, or
the total number of the subcarriers in all the OFDM symbols used for ETS embedded within one RU inside a data filed is divisible by the number of data subcarriers in the corresponding RU, or
all subcarriers of one or more RUs in all OFDM symbols within a data field are embedded with ETS.

8. First communication device as defined in any one of the preceding embodiments, wherein the processing circuitry is configured to determine which ERUBs to reserve for embedding ETSs.

9. First communication device as defined in embodiment 8, wherein the processing circuitry is configured to determine the locations of reserved ERUBs, in time and/or frequency domain, to embed ETSs based on information about interference collected by the first communication device and/or the second communication device.

10. First communication device as defined in embodiment 4 or 9, wherein the information about interference comprises one or more of type of interference, location of interference in time and/or frequency domain, periodicity of interference, coherence time and/or bandwidth of interference, number of interference spatial streams, and spatial channel correlation of interference.

11. First communication device as defined in any one of the preceding embodiments, wherein the processing circuitry is configured to reserve all subcarriers of one or more ERUBs that span the complete bandwidth of a RU and to embed one or more ETSs into the reserved subcarriers covering one or more OFDM symbols.

12. First communication device as defined in any one of the preceding embodiments, wherein the processing circuitry is configured to reserve all subcarriers of one or more ERUBs and to embed one or more ETSs in the reserved subcarriers covering all OFDM symbols in the data field.

13. First communication device as defined in any one of the preceding embodiments, wherein the processing circuitry is configured to add, into the one or more spatial streams or into one or more data units, signaling information indicating one or more of:
presence of ETSs in a spatial stream or a data unit;
location in time and/or frequency domain, and/or amount of ETSs embedded into spatial stream or a data unit;
predefined pattern of embedding ETSs into a data unit;
adoption of instruction of the second communication device;
type of ERUBs used for embedding one or more ETSs, the type of ERUB indicating if an ERUB is completely used, half used or partly used for embedding ETSs.

14. First communication device as defined in any one of the preceding embodiments, wherein the processing circuitry is configured to reserve one or more subcarriers of an ERUB and to embed one or more ETSs into the reserved subcarriers of ERUBs, wherein an ERUB is completely used, half used or partly used for embedding one or more ETSs.

15. First communication device as defined in any one of the preceding embodiments, wherein the processing circuitry comprises
a binary convolutionally encoded (BCC) interleaver, configured to perform a permutation to encoded data bits in BCC interleaver blocks of fixed size within an RU, and
a constellation mapper configured to map encoded data bits into complex data symbols, and
a tone mapper configured to map the complex data symbols into data subcarriers of an ERUB, wherein the number of complex data symbols containing one or more BCC interleaver blocks is equal to the number of data subcarriers in an ERUB that is half or partially used for embedding ETS.

16. First communication device as defined in any one of the preceding embodiments, wherein the processing circuitry comprises a constellation mapper configured to map encoded data bits into complex data symbols, and a low-density parity-check (LDPC) interleaver configured to perform a permutation to the complex data symbols and map them with a determined mapping distance into data subcarriers of an ERUB, wherein the mapping distance is an integer number that divides the number of data subcarriers in an ERUB, that is half or partially used for embedding ETS, into integer parts.

17. First communication device as defined in any one of the preceding embodiments, wherein the processing circuitry is configured to use an ETS mapping matrix for mapping the one or more ETSs into the one or more reserved subcarriers within an ERUB.

18. First communication device as defined in any one of the preceding embodiments, wherein the processing circuitry is configured to
reserve subcarriers in one or more mixed OFDM symbols in the data field to embed one or more ETS, a mixed OFDM symbol comprising data subcarriers and ETS subcarriers, and/or,
reserve all subcarriers in one or more OFDM symbols in the data field to embed one or more ETS into the reserved subcarriers of OFDM symbols, wherein the number of OFDM symbols is not equal to the number of long training field (LTF) symbols.

19. Second communication device configured to receive data from a first communication device, the second communication device comprising circuitry configured to:
extract, from a received data stream, one or more embedded training sequences (ETSs) that are embedded into one or more reserved subcarriers within one or more ETS RU blocks (ERUBs) that are reserved in one or more OFDM symbols in the data field of a data unit, wherein an ERUB spans part of or the complete bandwidth of a resource unit (RU);
extract, from the received data stream, payload data of each of one or more spatial streams mapped into data fields of data units, wherein a data unit comprises a preamble and a data field carrying one or more OFDM symbols and wherein one or more resource units are allocated to a data unit;
reconstruct a number of one or more spatial streams, each spatial stream carrying payload data; and
perform detection and/or estimation of interference and/or channel state based on the extracted ETSs.

20. Second communication device as defined in embodiment 19, wherein the processing circuitry is configured to extract, from the received data stream, signaling information indicating one or more of:
presence of ETSs in a spatial stream or a data unit;
location in time and/or frequency domain, and/or amount of ETSs embedded into spatial stream or a data unit;
predefined pattern of embedding ETSs into a data unit;
adoption of instruction of the second communication device;
type of ERUBs used for embedding one or more ETSs, the type of ERUB indicating if an ERUB is completely used, half used or partly used for embedding ETSs.

21. Second communication device as defined in embodiment 19 or 20, wherein the processing circuitry is configured to determine one or more of:
the type of interference by statistical analysis of interference channels observed in the ETSs of several received data units;
the frequency structure within the interference by detecting changes of the interference energy detected in subcarriers;
the time structure within the interference by detecting changes of the interference energy detected in OFDM symbols; and
the spatial structure within the interference by estimating the rank and spatial correlation matrix of the interference channel within a group of subcarriers and/or OFDM symbols.

22. Second communication device as defined in embodiment 19, 20 or 21, wherein the processing circuitry is configured to update the receiver MIMO equalizer based on estimated interference and/or channel state.

23. First communication method of a first communication device for transmitting data to a second communication device, the first communication method comprising:
generating a number of one or more spatial streams, each spatial stream carrying payload data;
mapping the payload data of each of the one or more spatial streams into a data field of a data unit, wherein a data unit comprises a preamble and a data field carrying one or more OFDM symbols and wherein one or more resource units (RU) are allocated to a data unit;
reserving one or more subcarriers within one or more embedded training sequences (ETS) RU blocks (ERUBs) in one or more OFDM symbols in the data field of a data unit, wherein an ERUB spans part of or the complete bandwidth of a RU; and embedding one or more embedded training sequences, ETSs, into the one or more reserved subcarriers within one or more ERUBs.

24. Second communication method of a second communication device for receiving data from a first communication device, the second communication method comprising:
extracting, from a received data stream, one or more embedded training sequences (ETSs) that are embedded into one or more reserved subcarriers within one or more ETS RU blocks (ERUBs) that are reserved in one or more OFDM symbols in the data field of a data unit, wherein an ERUB spans part of or the complete bandwidth of a resource unit (RU);
extracting, from the received data stream, payload data of each of one or more spatial streams mapped into data fields of data units, wherein a data unit comprises a preamble and a data field carrying one or more OFDM symbols and wherein one or more resource units are allocated to a data unit;
reconstructing a number of one or more spatial streams, each spatial stream carrying payload data; and
performing detection and/or estimation of interference and/or channel state based on the extracted ETSs.

25. A non-transitory computer-readable recording medium that stores therein a computer program product, which, when executed by a processor, causes the method according to embodiment 23 or 24 to be performed.

26. A computer program comprising program code means for causing a computer to perform the steps of said method according to embodiment 23 or 24 when said computer program is carried out on a computer.

1. First communication device configured to transmit data to a second communication device, the first communication device comprising circuitry configured to:
generate a number of one or more spatial streams, each spatial stream carrying payload data;
map the payload data of each of the one or more spatial streams into a data field of a data unit, wherein a data unit comprises a preamble and a data field carrying one or more OFDM symbols and wherein one or more resource units (RU) are allocated to a data unit;
reserve one or more subcarriers within one or more embedded training sequences (ETS) RU blocks (ERUBs) in one or more OFDM symbols in the data field of a data unit, wherein an ERUB spans part of or the complete bandwidth of a RU; and
embed one or more ETSs into the one or more reserved subcarriers within one or more ERUBs.

2. First communication device as claimed in claim 1,
wherein the processing circuitry is configured to determine the amount of ETSs to be embedded into a data field of a data unit and/or to determine the amount of ETSs so that the total number of subcarriers in all OFDM symbols used for the ETS embedding is upper bounded by a metric defined as a difference between the number of subcarriers over all employed OFDM symbols, weighted by a training efficiency factor, and the total number of subcarriers used for channel estimation during the preamble.

3. First communication device as claimed in claim 2,
wherein the processing circuitry is configured to determine the amount of ETSs to be embedded into a data field of a data unit based on information about interference collected by the first communication device and/or the second communication device and/or an instruction to increase or decrease the amount.

4. First communication device as claimed in claim 1,
wherein the processing circuitry is configured to not to embed ETSs in the last OFDM symbol carried in a data field.

5. First communication device as claimed in claim 1,
wherein the processing circuitry is configured to check, before mapping payload data into a data field of a data unit, if one or more granularity conditions with respect to the spatial streams are fulfilled once the one or more ETSs are embedded.

6. First communication device as claimed in claim 5,
wherein the processing circuitry is configured to check, as granularity condition, if
the total number of subcarriers in all the OFDM symbols used for ETS embedded inside a data field is divisible by the number of data subcarriers of an OFDM symbol for which no ETS embedding is performed, or
the total number of the subcarriers in all the OFDM symbols used for ETS embedded within one RU inside a data filed is divisible by the number of data subcarriers in the corresponding RU, or
all subcarriers of one or more RUs in all OFDM symbols within a data field are embedded with ETS.

7. First communication device as claimed in claim 1,
wherein the processing circuitry is configured to determine which ERUBs to reserve for embedding ETSs and/or to determine the locations of reserved ERUBs, in time and/or frequency domain, to embed ETSs based on information about interference collected by the first communication device and/or the second communication device.

8. First communication device as claimed in claim 3 or 7,
wherein the information about interference comprises one or more of type of interference, location of interference in time and/or frequency domain, periodicity of interference, coherence time and/or bandwidth of interference, number of interference spatial streams, and spatial channel correlation of interference.

9. First communication device as claimed in claim 1,
wherein the processing circuitry is configured to reserve all subcarriers of one or more ERUBs that span the complete bandwidth of a RU and to embed one or more ETSs into the reserved subcarriers covering one or more OFDM symbols and/or to reserve all subcarriers of one or more ERUBs and to embed one or more ETSs in the reserved subcarriers covering all OFDM symbols in the data field.

10. First communication device as claimed in claim 1,
wherein the processing circuitry is configured to add, into the one or more spatial streams or into one or more data units, signaling information indicating one or more of:
presence of ETSs in a spatial stream or a data unit;
location in time and/or frequency domain, and/or amount of ETSs embedded into spatial stream or a data unit;
predefined pattern of embedding ETSs into a data unit;
adoption of instruction of the second communication device;
type of ERUBs used for embedding one or more ETSs, the type of ERUB indicating if an ERUB is completely used, half used or partly used for embedding ETSs.

11. First communication device as claimed in claim 1,
wherein the processing circuitry is configured to reserve one or more subcarriers of an ERUB and to embed one or more ETSs into the reserved subcarriers of ERUBs, wherein an ERUB is completely used, half used or partly used for embedding one or more ETSs.

12. First communication device as claimed in claim 1,
wherein the processing circuitry comprises
either i):
a binary convolutionally encoded (BCC) interleaver, configured to perform a permutation to encoded data bits in BCC interleaver blocks of fixed size within an RU, and
a constellation mapper configured to map encoded data bits into complex data symbols, and
a tone mapper configured to map the complex data symbols into data subcarriers of an ERUB, wherein the number of complex data symbols containing one or more BCC interleaver blocks is equal to the number of data subcarriers in an ERUB that is half or partially used for embedding ETS;
or ii):
a constellation mapper configured to map encoded data bits into complex data symbols, and
a low-density parity-check (LDPC) interleaver configured to perform a permutation to the complex data symbols and map them with a determined mapping distance into data subcarriers of an ERUB, wherein the mapping distance is an integer number that divides the number of data subcarriers in an ERUB, that is half or partially used for embedding ETS, into integer parts.

13. First communication device as claimed in claim 1,
wherein the processing circuitry is configured to use an ETS mapping matrix for mapping the one or more ETSs into the one or more reserved subcarriers within an ERUB.

14. Second communication device configured to receive data from a first communication device, the second communication device comprising circuitry configured to:
extract, from a received data stream, one or more embedded training sequences (ETSs) that are embedded into one or more reserved subcarriers within one or more ETS RU blocks (ERUBs) that are reserved in one or more OFDM symbols in the data field of a data unit, wherein an ERUB spans part of or the complete bandwidth of a resource unit (RU);
extract, from the received data stream, payload data of each of one or more spatial streams mapped into data fields of data units, wherein a data unit comprises a preamble and a data field carrying one or more OFDM symbols and wherein one or more resource units are allocated to a data unit;
reconstruct a number of one or more spatial streams, each spatial stream carrying payload data; and
perform detection and/or estimation of interference and/or channel state based on the extracted ETSs.

15. Second communication device as claimed in claim 14,
wherein the processing circuitry is configured to extract, from the received data stream, signaling information indicating one or more of:
presence of ETSs in a spatial stream or a data unit;
location in time and/or frequency domain, and/or amount of ETSs embedded into spatial stream or a data unit;
predefined pattern of embedding ETSs into a data unit;
adoption of instruction of the second communication device;
type of ERUBs used for embedding one or more ETSs, the type of ERUB indicating if an ERUB is completely used, half used or partly used for embedding ETSs.

16. Second communication device as claimed in claim 14,
wherein the processing circuitry is configured to determine one or more of:
the type of interference by statistical analysis of interference channels observed in the ETSs of several received data units;
the frequency structure within the interference by detecting changes of the interference energy detected in subcarriers;
the time structure within the interference by detecting changes of the interference energy detected in OFDM symbols; and
the spatial structure within the interference by estimating the rank and spatial correlation matrix of the interference channel within a group of subcarriers and/or OFDM symbols.

17. Second communication device as claimed in claim 14,
wherein the processing circuitry is configured to update the receiver MIMO equalizer based on estimated interference and/or channel state.

18. First communication method of a first communication device for transmitting data to a second communication device, the first communication method comprising:
generating a number of one or more spatial streams, each spatial stream carrying payload data;
mapping the payload data of each of the one or more spatial streams into a data field of a data unit, wherein a data unit comprises a preamble and a data field carrying one or more OFDM symbols and wherein one or more resource units (RU) are allocated to a data unit;
reserving one or more subcarriers within one or more embedded training sequences (ETS) RU blocks (ERUBs) in one or more OFDM symbols in the data field of a data unit, wherein an ERUB spans part of or the complete bandwidth of a RU; and
embedding one or more embedded training sequences, ETSs, into the one or more reserved subcarriers within one or more ERUBs.

19. Second communication method of a second communication device for receiving data from a first communication device, the second communication method comprising:
extracting, from a received data stream, one or more embedded training sequences (ETSs) that are embedded into one or more reserved subcarriers within one or more ETS RU blocks (ERUBs) that are reserved in one or more OFDM symbols in the data field of a data unit, wherein an ERUB spans part of or the complete bandwidth of a resource unit (RU);
extracting, from the received data stream, payload data of each of one or more spatial streams mapped into data fields of data units, wherein a data unit comprises a preamble and a data field carrying one or more OFDM symbols and wherein one or more resource units are allocated to a data unit;
reconstructing a number of one or more spatial streams, each spatial stream carrying payload data; and
performing detection and/or estimation of interference and/or channel state based on the extracted ETSs.

20. A non-transitory computer-readable recording medium that stores therein a computer program product, which, when executed by a processor, causes the method according to claim 18 or 19 to be performed.
